(19) United States
(12) Patent Application Publication
(10) Pub. No.: US 2013/0317994 A1
(43) Pub. Date: Nov. 28, 2013

(54) INTELLECTUAL PROPERTY GENERATION SYSTEM

(71) Applicant: Bao Tran, Saratoga, CA (US)

(72) Inventor: Bao Tran, Saratoga, CA (US)

(21) Appl. No.: 13/676,086

(22) Filed: Nov. 13, 2012

Related U.S. Application Data
(60) Provisional application No. 61/558,777, filed on Nov. 11, 2011.

(51) Int. Cl. G06Q 50/18; G06Q 10/10

(52) U.S. Cl. CPC G06Q 50/184; G06Q 10/10
USPC 705/310

(57) ABSTRACT

Systems and methods are disclosed to generate a patent application by receiving an invention disclosure; locating key concepts in the invention disclosure and searching for patent references of interest; displaying sample patent references without user request to use as drafting examples; receiving one or more drawings generated by a group consisting of a camera, a diagramming tool, a drawing tool, a presentation tool, a word document editor; annotating the drawings with reference numerals and pointer lines; moving the reference numerals and pointer lines to desired positions; generating text description for each drawing; diagnosing the text description to comply with formality requirements; and generating the patent application.

The present application claims priority to Provisional Application Ser. No. 61/558,777, filed Nov. 11, 2011, the content of which is incorporated by reference.

### BACKGROUND

The present invention pertains to an intellectual property generation system.

Innovation—both in the United States and throughout the world—is growing at a record pace. This growth makes the United States an attractive market for both domestic and foreign companies. Its stable economy, commitments to the rule of law, business values—and strong IP system—combine to create the most favorable trade environment in the world. The United States is not the only country experiencing dramatic economic growth and prosperity. A trend that is anticipated to grow—possibly at historic rates—is the large percentage of foreign applicants who file patent and trademark applications in the United States. A recent study conducted by WIPO noted that the United States, through the USPTO, receives more foreign patent applications than does any other patent office in the world—for example, 182,866 patent utility applications in 2005 or 107 percent more than in 1995.

On 16 Sep. 2011, President Obama signed into law Senator Patrick Leahy (D-Vt.) and Congressman Lamar Smith's (R-Texas) patent reform bill, the Leahy-Smith America Invents Act. The Act makes major changes to the U.S. patent system. Among the changes, the United States will no longer award a patent right—the right to exclude others from making, using, or selling an invention—to the entity that first invents. Instead, the United States will award patent rights to the first entity to file for a patent. This first to file system will begin 18 months after the Act's passage.

The first to file system, with prior user rights, may burden small businesses and individual inventors as they will likely end up with increased costs from having to compress the timeline in which they innovate, identify patentable innovations, and then thereafter seek a patent. If the smaller entity does not adopt a compressed timeline, the entity will either lose patent rights forever, or be subject to threats from a competitor's patent, including the litigation costs associated with proving prior use. Larger, established businesses will probably be able to incorporate the innovation costs, investment costs, and legal costs of a first to file system more easily, giving them the advantage. For independent inventors the new law will mean more reliance on non-disclosure agreements and use of provisional patents. Inventors will need to be more serious and focused.

Larger technology companies, perhaps through economies of scale, will probably be better able to incorporate the compressed timeline of innovating, determining marketability, and applying for patents that cover as many critical areas as possible. If successful, these patent holders will probably be able to leverage the litigation costs of proving prior use over even legitimate first inventors. To compete for patents, and to better defend themselves, small businesses and individual innovators need to win the race to the patent office. To win the race, small business innovators must begin to prepare and file provisional patent applications.

A provisional patent application is a less formal, less expensive, but legally sufficient way to obtain an early filing date for an invention. Provisional patent applications, while relatively informal, still require the involvement of patent counsel because a provisional application still requires the inclusion of certain elements. Only with those elements will the USPTO permit an inventor to later file a non-provisional, full-blown patent application that could ultimately be allowed as a patent.

For these reasons, a need exists for a tool that helps inventors to properly prepare provisional patent applications and include the language requisite to achieve the inventors' aims. When done correctly, small businesses can use provisional patents to bear the innovation costs, investment costs, and legal costs of the new first to file system and its weak prior user rights. Limiting these costs will enable small businesses to compete.

Due to the importance of patents, an easy to use, cost-effective, high quality process for generating patent application is needed.

### SUMMARY

Systems and methods are disclosed to generate a patent application by receiving an invention disclosure; locating key concepts in the invention disclosure and searching for patent references of interest; displaying sample patent references without user request to use as drafting examples; receiving one or more drawings generated by a group consisting of a camera, a diagramming tool, a drawing tool, a presentation tool, a word document editor; annotating the drawings with reference numerals and pointer lines; moving the reference numerals and pointer lines to desired positions; generating text description for each drawing; diagnosing the text description to comply with formality requirements; and generating the patent application.

In another aspect, systems and methods are disclosed to generate a patent application by receiving an invention disclosure; identifying noun phrases in the invention disclosure as claim element candidates; displaying the noun phrases graphically on a screen as user moveable blocks with dependency information shown as links to one or more other blocks; and generating claims from the user moveable blocks.

In yet another aspect, systems and methods are disclosed to generate a patent application by receiving an invention disclosure; locating key concepts in the invention disclosure and searching for patent references of interest; displaying sample patent references without user request to use as drafting examples; receiving one or more drawings generated by a group consisting of a camera, a diagramming tool, a drawing tool, a presentation tool, a word document editor; annotating the drawings with reference numerals and pointer lines; moving the reference numerals and pointer lines to desired positions; generating text description for each drawing; diagnosing the text description to comply with formality requirements; identifying noun phrases in the invention disclosure as claim element candidates; displaying the noun phrases graphically on a screen as user moveable blocks with dependency information shown as links to one or more other blocks; and generating claims from the user moveable blocks; and generating the patent application.

In another aspect, a method to generate a patent application includes receiving an invention disclosure; identifying noun phrases in the invention disclosure as claim element candidates; displaying the noun phrases graphically on a screen as user moveable blocks with dependency information shown as links to one or more other blocks; and generating claims from the user moveable blocks.

Implementations of the above aspect can include one or more of the following. The method includes mind-mapping the invention disclosure. The user can drag a first block to a second block to indicate dependency between the first and second blocks. The method includes generating claims based on noun phrases and links. The method includes assigning numbers to the noun phrases. Drawings are generated with the assigned numbers. The system prompts the user for generating detailed description text for each noun phrase. The method includes synthesizing a detailed description of the invention from the detailed description text for each noun phrase. The method can display definition or synonym for each noun phrase element. The system can search patent database for matching descriptions of a noun phrase and displaying the matching descriptions. A diagnostic report for the patent application. A PDF can be generated for uploading to a patent office web site.

Advantages of the preferred embodiment may include one or more of the following. The system is easy to use. The user can explain his ideas in plain English and in a brief document such as an invention disclosure. The system then guides the user on how to claim his or her invention in an intuitive graphical style that does not require significant training. The user is then guided in systematically explaining the invention as distilled in the claims. Due to this systematic process, the inventor is guided to thoroughly describe his invention in a visual, easy to use approach that meets the PTO requirement without requiring significant training in patent drafting. The resulting application is high in quality because it is vetted through automated diagnostics. The process thus supports the drafting of high quality patent applications in a cost-effective manner.

Implementations of the above aspect may include one or more of the following.

Various aspects and embodiments of the invention are described in further detail below.

### BRIEF DESCRIPTION OF THE DRAWINGS

The present invention described herein will become apparent from the following detailed description considered in connection with the accompanying drawings, which disclose several embodiments of the invention. It should be understood, however, that the drawings are designed for the purpose of illustration and not as limits of the invention.

FIG. 1 shows an exemplary computer system that operates over the Internet.

FIG. 2 shows an exemplary process for generating a patent application.

FIG. 3 shows an exemplary process for generating a detailed description of the invention.

FIG. 4 shows an exemplary page to provide an overview of the new invention to be patented.

FIG. 5 shows an exemplary page for editing a figure and describing the figure.

FIG. 6 shows an exemplary page to collect inventorship data and to generate a cover sheet.

FIG. 7 shows an exemplary diagnostic output page.

FIG. 8 shows an exemplary filing option user interface.

FIG. 9 shows an exemplary help system.

FIG. 10 shows an exemplary diagnostic report.

FIG. 11 shows an exemplary on-line filing interface.

FIG. 12 shows an exemplary user interface on a tablet computer.

FIG. 13 shows an exemplary process to generate a utility patent application.

FIG. 14 shows an exemplary process to generate claims.

FIG. 15 shows an exemplary user interface to graphically sketch claims.

FIG. 16 shows an exemplary system that allows a user to graphically generate a claim outline.

FIG. 17 shows an exemplary process for automatically enhancing the inventor's ideas.

FIG. 18A-18B show one embodiment of a system for gathering data to help complete a patent application, while FIG. 18C shows an exemplary process for clustering concepts.

FIGS. 19A-19C show one exemplary embodiment for amplifying an inventive concept and auto-generating the text for the amplified concept.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The system may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

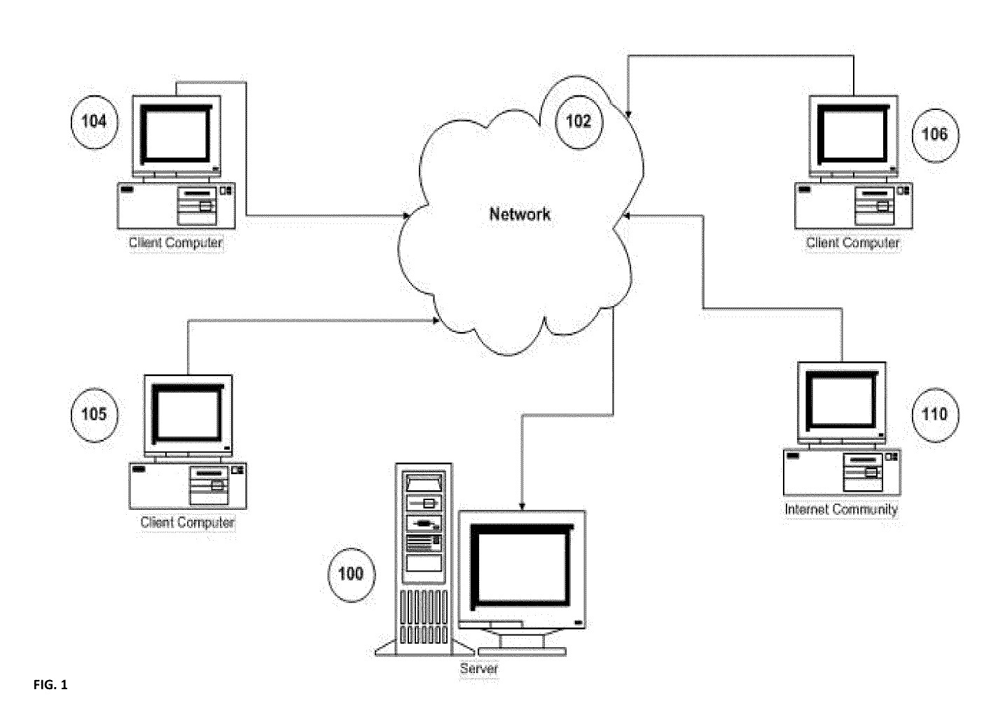

FIG. 1 shows an exemplary computer system that operates over the Internet as described below. A server 100 is connected to a network 102 such as the Internet. One or more client workstations 104-106 are also connected to the network 102. The client workstations 104-106 can be personal computers, thin clients, or workstations running browsers such as Firefox or Internet Explorer. With the browser, a client or user can access the server 100's Web site by clicking in the browser's Address box, and typing the address (for example, www.mailrancher.com), then press Enter. When the page has finished loading, the status bar at the bottom of the window is updated. The browser also provides various buttons that allow the client or user to traverse the Internet or to perform other browsing functions.

An Internet community 110 with one or more service providers, manufacturers, or marketers is connected to the network 102 and can communicate directly with users of the client workstations 104-106 or indirectly through the server 100. The Internet community 110 provides the client workstations 104-106 with access to the Web for commerce.

Although the server 100 can be an individual server, the server 100 can also be a cluster of redundant servers. Such a cluster can provide automatic data failover, protecting against both hardware and software faults. In this environment, a plurality of servers provides resources independent of each other until one of the servers fails. Each server can continuously monitor other servers. When one of the servers is unable to respond, the failover process begins. The surviving server acquires the shared drives and volumes of the failed server and mounts the volumes contained on the shared drives. Applications that use the shared drives can also be started on the surviving server after the failover. As soon as the failed server is booted up and the communication between servers indicates that the server is ready to own its shared drives, the servers automatically start the recovery process. Additionally, a cluster of servers or server farm can be used. Network requests and server load conditions can be tracked in real time by the server farm controller, and the request can be distributed across the farm of servers to optimize responsiveness and system capacity. When necessary, the farm can automatically and transparently place additional server capacity in service as traffic load increases.

The server 100 can also be protected by a firewall. When the firewall receives a network packet from the network 102, it determines whether the transmission is authorized. If so, the firewall examines the header within the packet to determine what encryption algorithm was used to encrypt the packet. Using this algorithm and a secret key, the firewall decrypts the data and addresses of the source and destination firewalls and sends the data to the server 100. If both the source and destination are firewalls, the only addresses visible (i.e., unencrypted) on the network are those of the firewall. The addresses of computers on the internal networks, and, hence, the internal network topology, are hidden. This is called “virtual private networking” (VPN).

The server 100 supports a document generating portal that provides a single point of integration, access, and navigation through the multiple enterprise systems and information sources facing knowledge users operating the client workstations 104-106. The portal can additionally support services that are transaction driven. Once such service is advertising: each time the user accesses the portal, the client workstation 104 or 106 downloads information from the server 100. The information can contain commercial messages/links or can contain downloadable software. Based on data collected on users, advertisers may selectively broadcast messages to users. Messages can be sent through banner advertisements, which are images displayed in a window of the portal. A user can click on the image and be routed to an advertiser's Web-site. Advertisers pay for the number of advertisements displayed, the number of times users click on advertisements, or based on other criteria. Alternatively, the portal supports sponsorship programs, which involve providing an advertiser the right to be displayed on the face of the port or on a drop down menu for a specified period of time, usually one year or less. The portal also supports performance-based arrangements whose payments are dependent on the success of an advertising campaign, which may be measured by the number of times users visit a Web-site, purchase products or register for services. The portal can refer users to advertisers' Web-sites when they log on to the portal.

Additionally, the portal offers contents and forums providing focused articles, valuable insights, questions and answers, and value-added information. Other services can be supported as well. For example, a user can rent space on the server to enable him/her to download application software (applets) and/or data—anytime and anywhere. By off-loading the storage on the server, the user minimizes the memory required on the client workstation 104-106, thus enabling complex operations to run on minimal computers such as handheld computers and yet still ensures that he/she can access the application and related information anywhere anytime. Another service is On-line Software Distribution/Rental Service. The portal can distribute its software and other software companies from its server. Additionally, the portal can rent the software so that the user pays only for the actual usage of the software. After each use, the application is erased and will be reloaded when next needed, after paying another transaction usage fee.

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

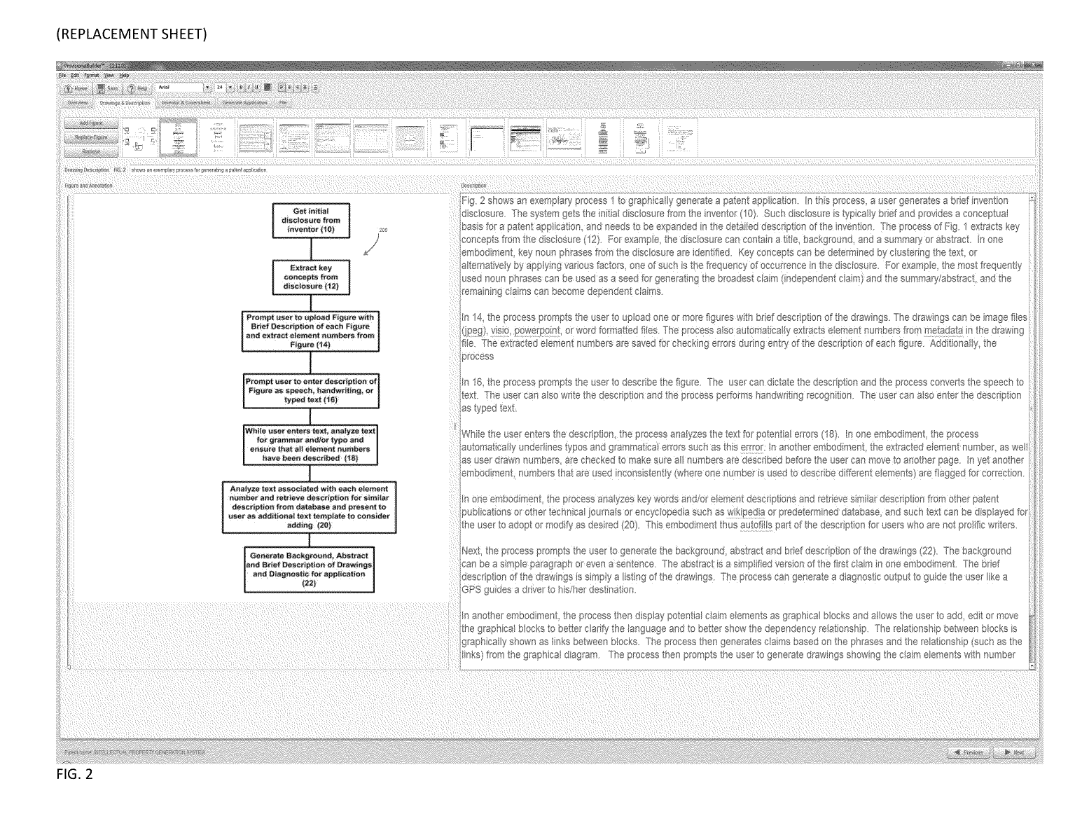

FIG. 2 shows an exemplary process for generating a patent application. FIG. 2 shows an exemplary process 200 to graphically generate a patent application. In this process, a user generates a brief invention disclosure. The system gets the initial disclosure from the inventor (10). Such disclosure is typically brief and provides a conceptual basis for a patent application, and needs to be expanded in the detailed description of the invention. The process of FIG. 1 extracts key concepts from the disclosure (12). For example, the disclosure can contain a title, background, and a summary or abstract. In one embodiment, key noun phrases from the disclosure are identified. Key concepts can be determined by clustering the text, or alternatively by applying various factors, one of such is the frequency of occurrence in the disclosure. For example, the most frequently used noun phrases can be used as a seed for generating the broadest claim (independent claim) and the summary/abstract, and the remaining claims can become dependent claims.

In 14, the process prompts the user to upload one or more figures with brief description of the drawings. The drawings can be image files (jpeg), visio, powerpoint, or word formatted files. The process also automatically extracts element numbers from metadata in the drawing file. The extracted element numbers are saved for checking errors during entry of the description of each figure. Additionally, the process allows the user to manually annotate the drawing with element numbers with pointers to region of interest. In the exemplary FIG. 2, the number and arrow are pointed at the whole figure. Further, the tip of the pointer can be moved, and the overall shape of the pointer can be adjusted when the cursor is placed near the arrow and turns into a hand with a blue dot that can be dragged to adjust the curvature and orientation of the arrow.

In 16, the process prompts the user to describe the figure. The user can dictate the description and the process converts the speech to text. The user can also write the description and the process performs handwriting recognition. The user can also enter the description as typed text.

While the user enters the description, the process analyzes the text for potential errors (18). In one embodiment, the process automatically underlines typos and grammatical errors such as this errror. In another embodiment, the extracted element number, as well as user drawn numbers, are checked to make sure all numbers are described before the user can move to another page. In yet another embodiment, numbers that are used inconsistently (where one number is used to describe different elements) are flagged for correction.

In one embodiment, the process analyzes key words and/or element descriptions and retrieves similar description from other patent publications or other technical journals or encyclopedia such as wikipedia or predetermined database, and such text can be displayed for the user to adopt or modify as desired (20). This embodiment thus autofills part of the description for users who are not prolific writers.

Next, the process prompts the user to generate the background, abstract and brief description of the drawings (22). The background can be a simple paragraph or even a sentence. The abstract is a simplified version of the first claim in one embodiment. The brief description of the drawings is simply a listing of the drawings. The process can generate a diagnostic output to guide the user like a GPS guides a driver to his/her destination.

In another embodiment, the process then display potential claim elements as graphical blocks and allows the user to add, edit or move the graphical blocks to better clarify the language and to better show the dependency relationship. The relationship between blocks is graphically shown as links between blocks. The process then generates claims based on the phrases and the relationship (such as the links) from the graphical diagram. The process then prompts the user to generate drawings showing the claim elements with number annotation. In one embodiment, the diagram with the graphical blocks can itself be used as a figure in support of the application. The process then prompts the user to provide more details and more description for each element and noun phrases. To assist the user, information from dictionary and thesaurus can be presented to help the user communicate more clearly. The details and dependency and relationship among the noun phrases and elements are described in depth in this manner.

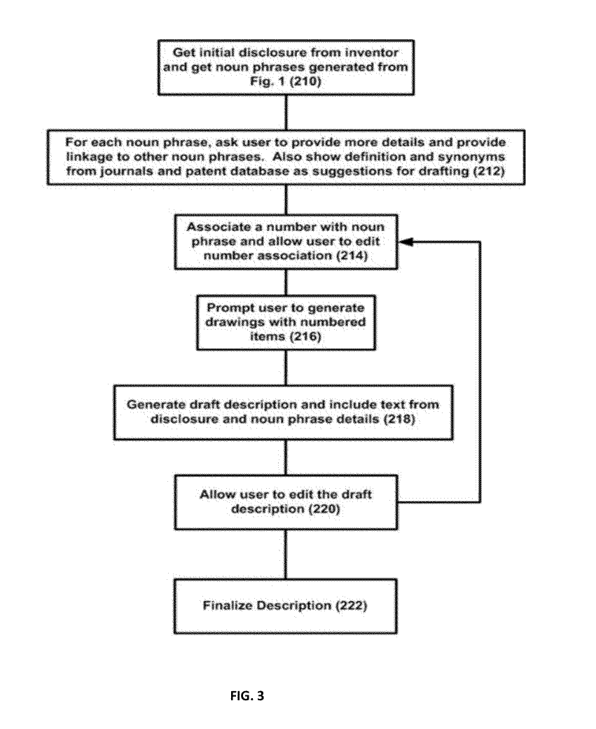

FIG. 3 shows an exemplary process for generating a detailed description of the invention. FIG. 3 shows an exemplary process to generate the detailed description of the invention. The process gets the initial disclosure as well as noun phrases and claim elements identified in FIG. 1-2 (210). Next, for each noun phrase, the process asks the user to provide more details on the element and on the relationship with other elements (212). The process prompts the user to associate a number with a noun phrase (214). In one embodiment, the noun phrase is automatically generated for the user and the user can edit/add/delete the number as desired. In another embodiment, the user can directly assign a number to an element. The process then asks the user to generate drawing(s) illustrating the part number on the drawing(s) (216).

The process then generates a draft detailed description of the invention for the user's invention (218). The draft description is simply an organized document containing the descriptions of the elements and noun phrases in a logical order. This can be done by following the claim sequencing in one embodiment. Alternatively, the system can follow the sequence provided in the invention disclosure and insert the additional text with the reference and reference numerals according to the sequence of the disclosure. In other embodiments, the process can generate text based on a predetermined order of the reference numerals.

The process allows the user to review, revise and edit the draft description as appropriate (220). Once the user accepts the draft, the process saves the description text as the final version (222).

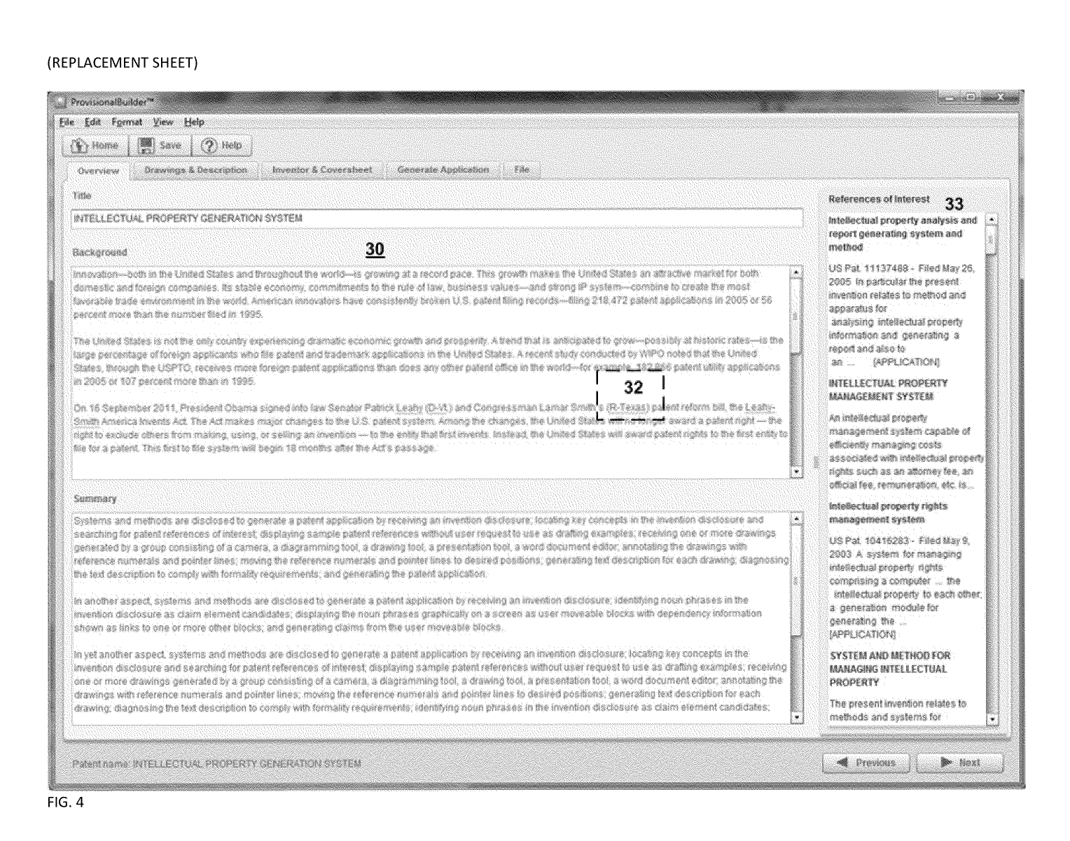

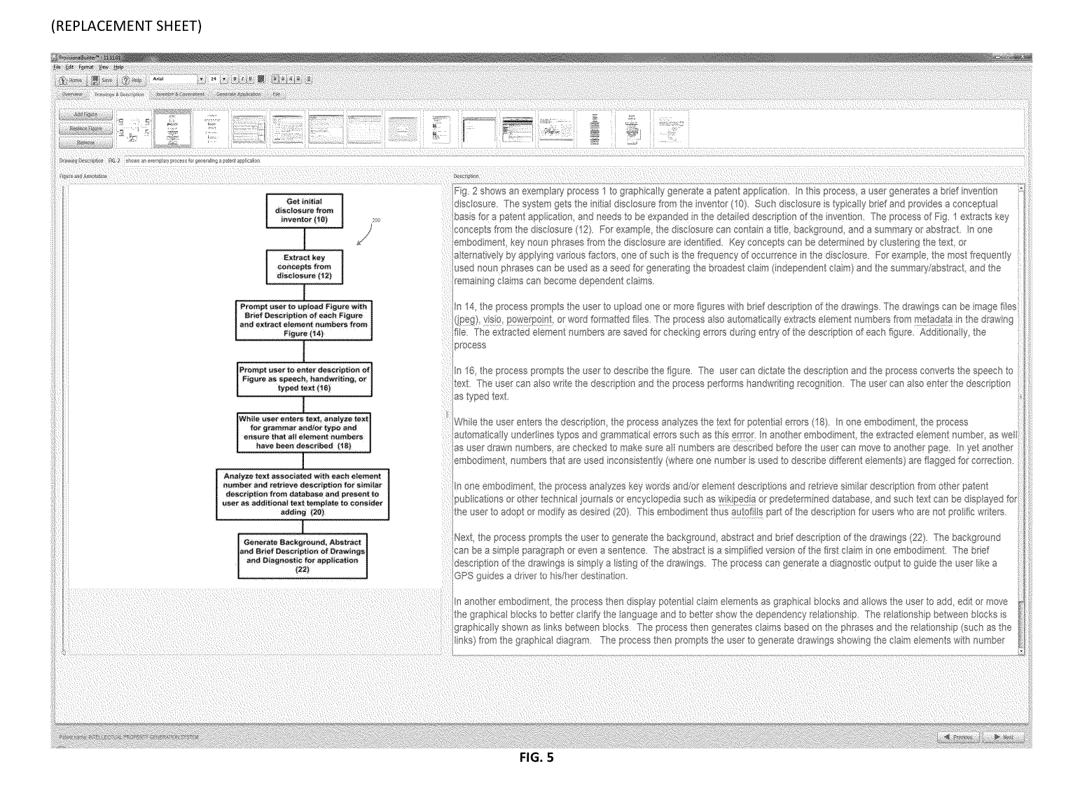

FIG. 4 shows an exemplary page to provide an overview of the new invention to be patented. Referring now to FIG. 4, an exemplary invention disclosure view or form 30 is shown. The title of the application should be descriptive of the invention, and should be less than 500 characters as specified by the USPTO.

As the user enters text into the title, the software automatically retrieves potentially interesting patents or published patent applications in the right column 33. The user can click on each document, and a PDF file for the document will be saved in a project directory and opened for his/her review. The user can use these documents as writing samples, and to see if they are relevant to the user's invention and if so he/she can focus text and diagrams to focus or emphasize aspects that will differentiate the invention from the reference. In case the user is not familiar with the format of patent documents, the PDF document will provide the user with example writing style to follow. The user may want to review the results to see if others have thought of the same invention already and if so the user may want to abandon the filing effort. Seeing how similar concepts are described in professionally written patent applications may also be helpful to the user in drafting his or her own text and can be an excellent way to learn how patent applications are written. Relevant documents are then saved for citing to the US PTO when the user converts the provisional application into a utility application.

The Background section 30 is a brief description of the issues or problems to be solved by your invention. It sets up the need for the invention. The user may want to describe existing solutions to these problems. In one implementation, a spell-checker is used to highlight potential errors 32.

Instead of focusing on the shortcomings of existing solutions in the Background section, it may be advantageous to focus on how the user's invention is superior to existing solution(s), and such description should be positively recited as advantages of the preferred embodiment in the Summary section.

The Summary section captures what the user considers to be the highlights of your invention. The user should describe the invention at a high level and reference only essential components or elements making up the invention. Also, be careful of liberally sprinkling the term “the invention” in the application, because terms used with “the invention” in the same sentence may become a required part of the invention even though you did not intend for this to occur. It is safer to say “In one implementation, the embodiment is a . . . ” rather than “The invention is a . . . .”

Non-essential or optional elements should be described later in the Detailed Description section along with the drawings illustrating their relationships to the essential elements. Alternatively, the user can list the optional elements in a separate paragraph that begins with an introductory sentence such as “Implementations of the system can include one or more of the following”.

The Background section 30 thus collects basic information about your invention. The user can enter the title or name of the invention in the first text region. In the second text region, the user can enter background information relating to your invention, and in the third text region, the user can enter a brief summary of your invention.

FIG. 5 shows an exemplary page for editing a figure and describing the figure. First, a series of drawings is prepared that illustrate the operation of exact embodiments or implementations of the user's invention. The user will also want to generate drawings for alternative ways to implement the invention to prevent others from designing-around your particular implementation of the invention. The drawings can be done by hand and digitized using a scanner or a camera. Alternatively, you can generate these diagrams using tools such as PowerPoint and Visio, among others, and import them or directly import images (jpeg or png). If the invention cannot be illustrated, but can be described using photographs, the user can take pictures of the invention and include them in the application. The picture can be taken from a standard digital camera, or can be done using a tablet or cell phone's camera.

After the images have been generated, easy to use tools help users import or capture drawings and describe these drawings in detail. The user can annotate these drawings with numbers up front, or can use Power Patent Provisional Builder™ to place reference numerals for elements. Tools are provided to help the user easily and quickly indicate element names and check consistency of usage from his or her text entry.

As shown in FIG. 5, thumbnails of each drawing are shown in a top bar. When the user clicks on the image thumbnail, an enlarged figure is shown on the bottom left, while text associated with the figure is shown on the right column. The user can annotate the drawing by clicking a pointer such as a mouse pointer near the desired area. A box with a red dot appears. The red dot is the tip of a pointer arrow. The user can drag the red dot to point it to the correct spot in the figure where the user wants the text to be associated with. The user can also select the number and move the number to a desired position.

The box has an automatically generated number that can be changed. Further, the user can add descriptive text after the number to provide more information. If the user enters text after the number, a colon will be shown to separate the text from the number. During printing of the figure, the descriptive text after the number will be suppressed. When the user clicks a mouse pointer near the desired area, a box with a red dot appears. The red dot is the tip of a pointer arrow. The user can drag the red dot to point it to the correct spot in the figure where the user wants the text to be associated. The user can also select the number and move the number to a desired position.

The box has an automatically generated number that can be changed. Further, the user can add descriptive text after the number to provide more information. If the user enters text after the number, a colon will be shown to separate the text from the number. During printing of the figure, the descriptive text after the number will be suppressed. When the user click on the pointer or the element number, the number is shown, along with a red dot indicating the tip of the pointer. The user can drag the red dot to point to a desired end target on the drawing. The user can also drag the number to a desired beginning target.

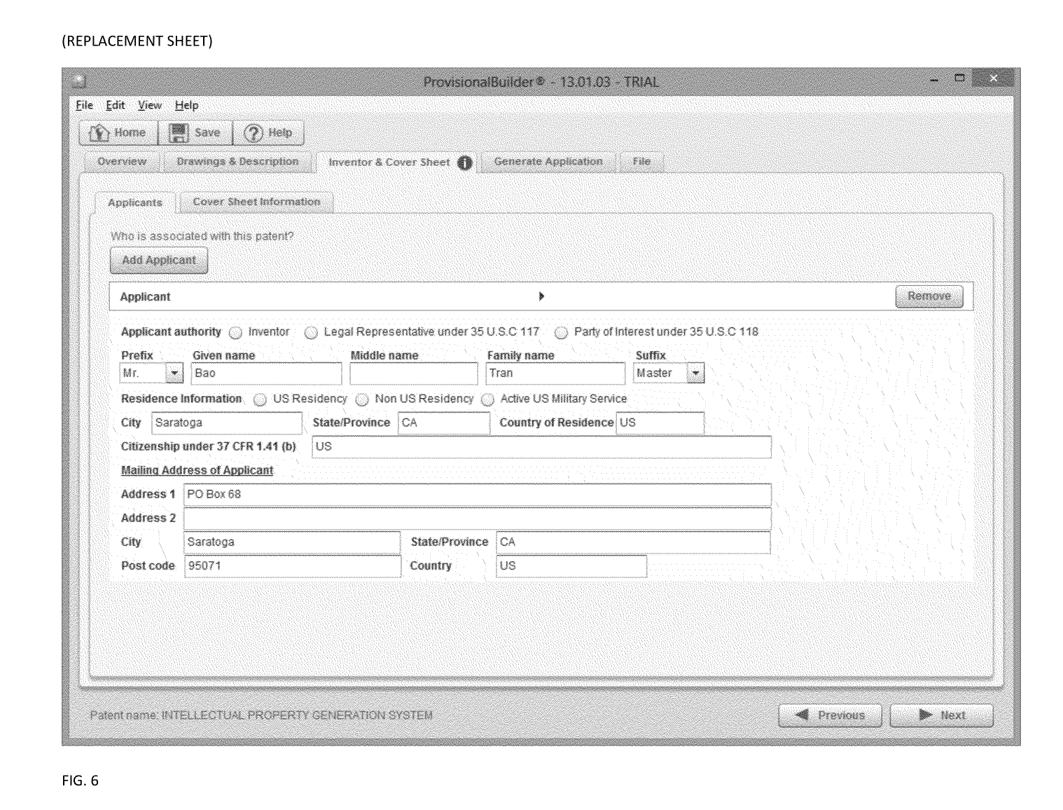

FIG. 6 shows an exemplary page to collect inventorship data and to generate a cover sheet. The exemplary inventorship capture page allows each Applicant data to be stored in a database that can be reused for future applications so that the inventor information is entered only once and can be reused in the future. Thus, if an inventor is common to two or more applications, the information needs to be entered only once. The information in the cover sheet is completed with the following:

The name(s) of the inventor(s) and city and state of residence;

The title of the invention;

The name and registration number of attorney or agent, and a docket or reference number, if applicable;

The correspondence address;

Any U.S. government agency with a property interest in the application; and

Small entity status.

The Cover Sheet is a facsimile of a PTO supplied form. The information captured in the coversheet and the inventor

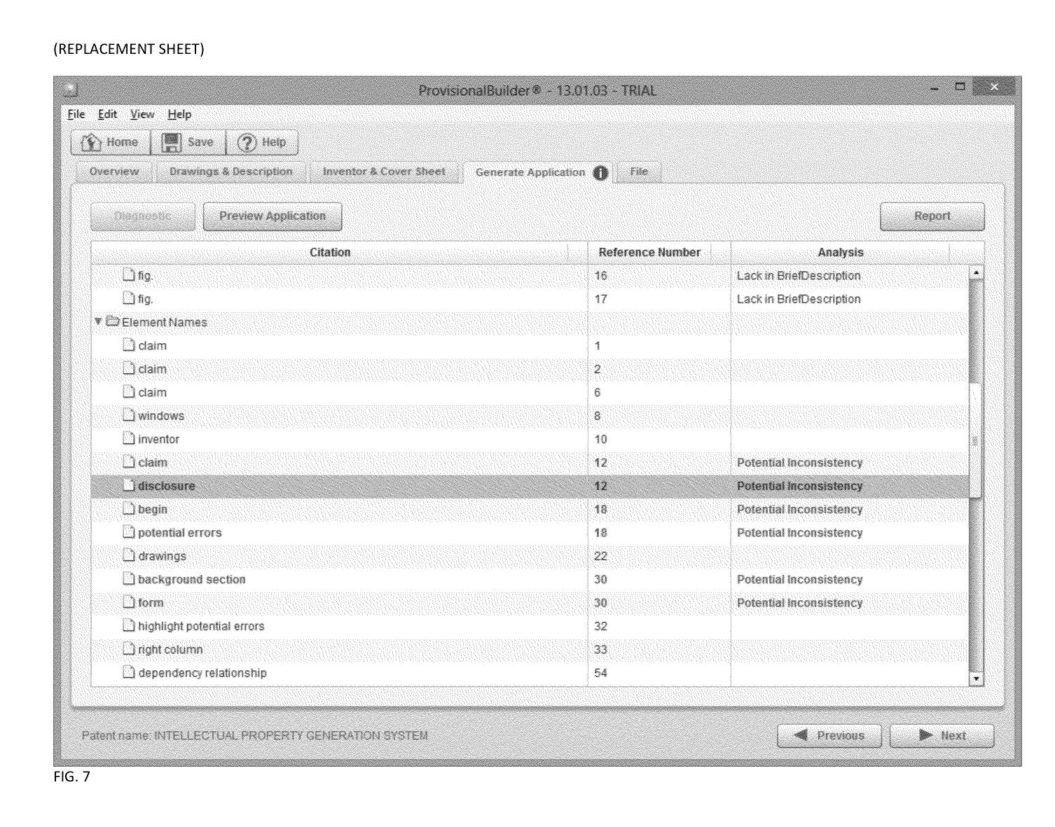

FIG. 7 shows an exemplary diagnostic output page. The software runs a check to make sure that users have used element numbers in a consistent manner. For utility applications, the diagnostic features antecedent basis checking and support for claim elements in the detailed description. The diagnostic can also extract numbers from the drawings (such as from Visio or Powerpoint drawing files), and compare the numbers to those in the text description. Additionally, the element numbers in the text description are also identified. Variances in the number and text description thereof are flagged for user review.

In one embodiment, the user can preview the application as a PDF document, save as a PDF document, or save as a Word document. Upon success, the PDF is generated so that the user can file the application. To simplify, the PDF can include the Cover Sheet form first, followed by the description and then by the drawings, all in one document for ease of handling. Alternatively, the coversheet can be separate from the application PDF.

When the user clicks on the Report button, a diagnostic report is generated. An exemplary report is shown in FIG. 10 below.

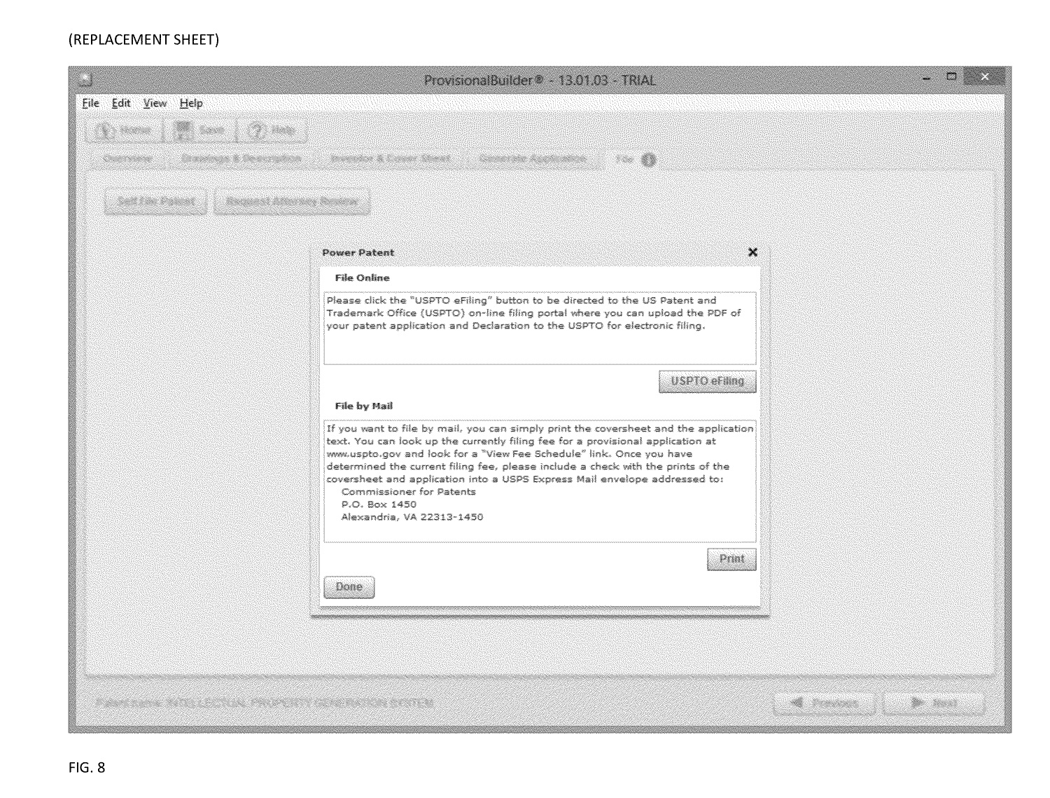

FIG. 8 shows an exemplary filing option user interface. The system allows the user to file using paper or file on-line. To file using paper, the software runs the text through a final diagnostics, and if acceptable, prints a copy of the application for mailing. To file on-line, the user simply clicks on the “File On-Line” button. This will launch a browser window to the unregistered efiler page such as the efiling page hosted by the USPTO. The user can enter name, email address, click on the appropriate patent filing document to upload to the efiling portal.

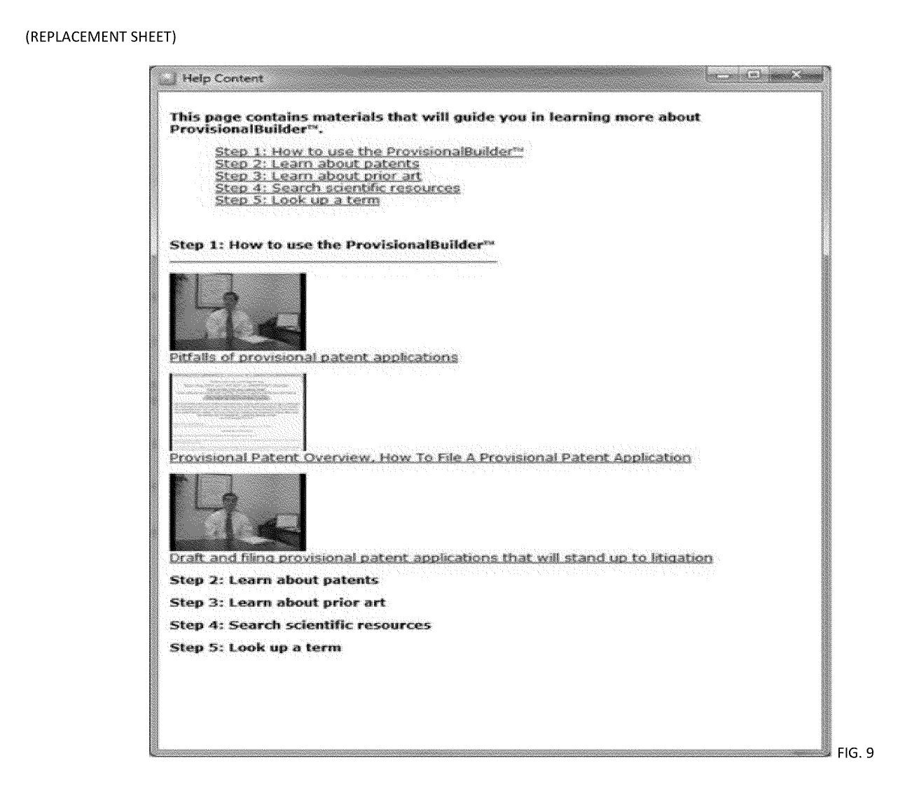

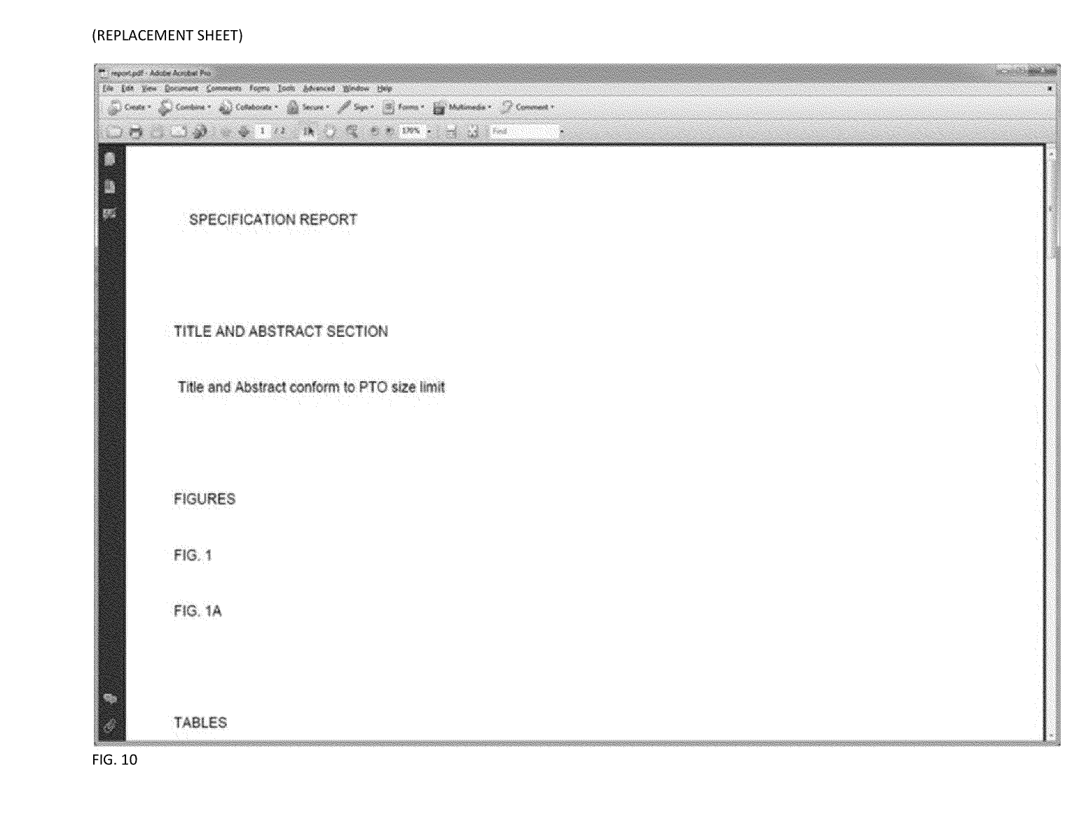

FIG. 9 shows an exemplary help system. The system contains video links that help explain how to use the software, as well as best practices in drafting applications. When the user clicks on a thumbnail of the video, the video is streamed for user viewing. The video can be embedded in the software, or can be streamed from a video streaming application over the internet such as youtube.com or other video sharing web sites.

FIG. 10 shows an exemplary diagnostic report. The system can create comprehensive reports that identify drawing reference anomalies, improper term and phrase usage, among others.

The diagnostic allows the user to draft high-quality patent applications with tools that help the user to check claims for proper antecedent basis/possible lack of support in the disclosure, terminology from other patents, multiple claim sets for new matter, and consistency in part labeling and numbering.

In one embodiment, the system can:

Check claim language for prior adjudications and prior art references and link to related cases and patents.

Spot ambiguous or missing antecedents and lack of support in drawings or descriptions.

Generate a navigable claim hierarchy on the fly.

Quickly research specific claim elements in the prior art leveraging advanced features such as automatic patent prior art search, and capture/associate prior art reference data into an auto-generated claim hierarchy.

Detect term and phrase differentials in claims and descriptions.

Automatically research specific claim elements in prior art and assimilate prior art reference data into an auto-generated claim hierarchy.

Quickly compare claim elements, terms, and phrases across multiple documents to detect new and deleted matter.

Match claim sets of multiple documents and easily identify claims that have been removed, modified or added.

Check Parts

Check the accuracy and consistency of your reference figures and related part numbers and labels.

Auto-insert part numbers into the abstract or claims for foreign filing or analysis.

Use shorthand notations for reciting parts while drafting.

Identify repeated parts for correction as necessary.

In another embodiment, the system can check references

Instantly retrieve patent citation references in granted or application and review related bibliographic information.

View a comprehensive post-issuance activity report for cited patents.

Investigate, verify, and export information related to the citations appearing in the patent application

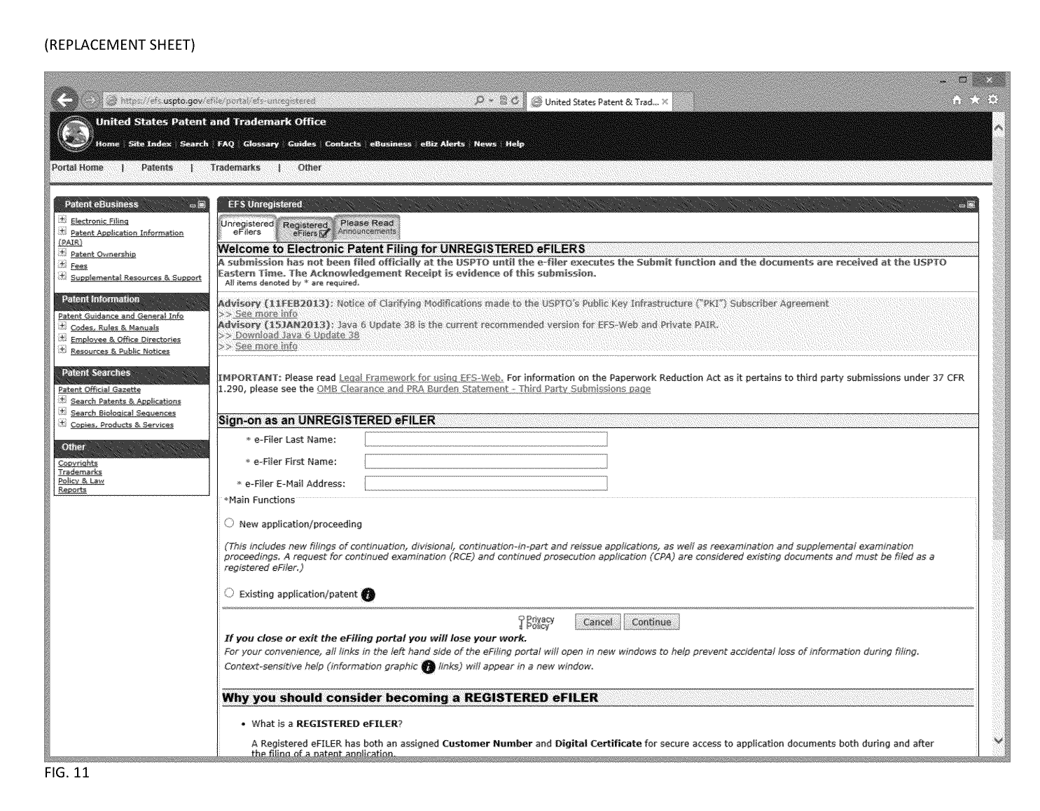

FIG. 11 shows an exemplary on-line filing interface. In one embodiment, the system then navigates to the USPTO EFS website and decide whether to start the session as an unregistered or registered system user. The main benefit to registration is the ability to save the application at any stage and return later. Unregistered users must complete the entire process in one sitting. The user can select “New application,” choose “Utility” as the application type and select “Provisional” from the list of options if the user is interested in filing a provisional patent application.

After clicking the “Continue” button, the user can fill out the information needed for the provisional patent application. The user can enter information on the “Application Data” screen and click continue. The user can select the PDF documents generated by the system to upload them to the server and click continue. After verifying that the documents are uploaded correctly, the user can continue to enter the “Fee Calculation” screen. The user can confirm all application options and the PTO fees and then submit the form. The user cna pay the fees with a credit card and print the receipt.

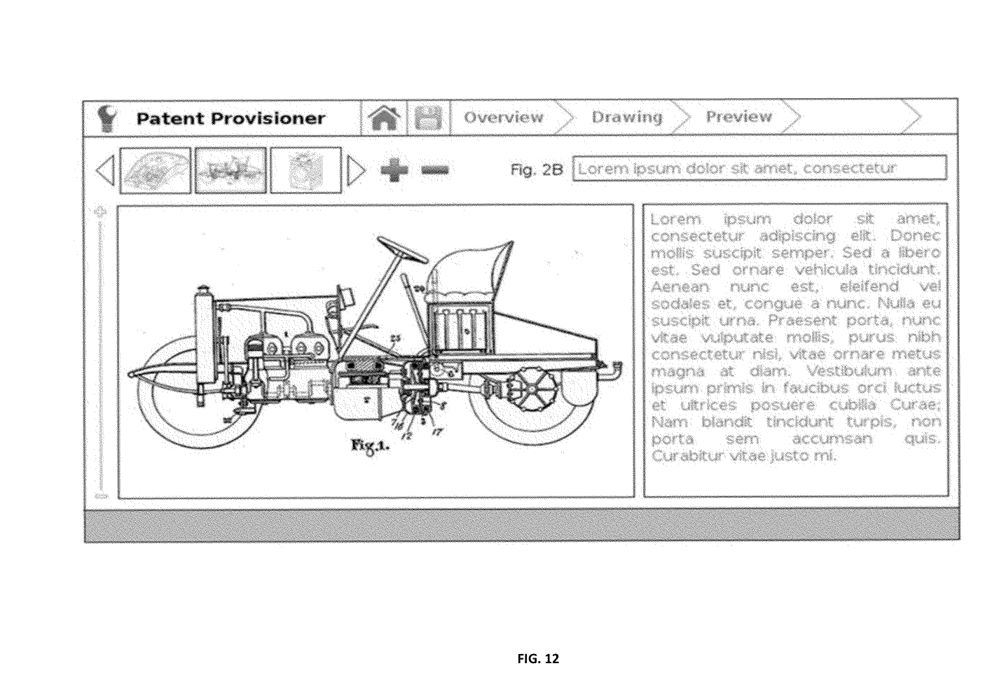

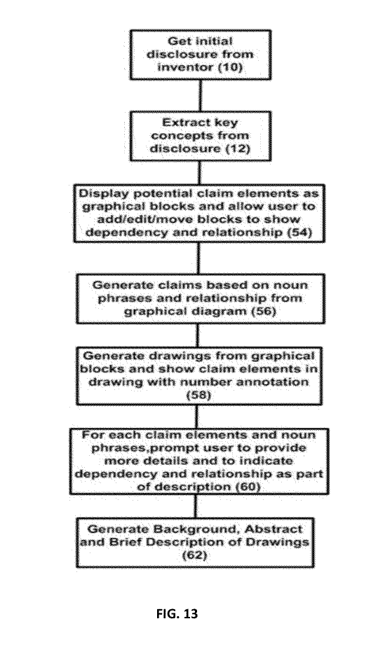

FIG. 12 shows an exemplary user interface on a tablet computer. This user interface can be for the Windows 8 tablet, Android tablet, or iPad tablet. The user of the tablet can use the tablet's built in camera to take pictures to use as Figures instead of importing the images. Thus, the user can hand draw the Figures and take snap shots of the paper. Alternatively, if a prototype is available, the user can take actual pictures and use the pictures in place of formal drawings. The pictures can be annotated with element numbers by the user.

In one embodiment, the system can use the Siri system to help the user generate text for the application. For example, the user can identify all noun phrases as part of element number names, and Siri can seek descriptions of the element names for user to select and edit. The use of smart agents to autofill element description is helpful in the keyless tablet environment. In another embodiment, the user can dictate the element names to the tablet speech recognizer, and the system can autofill text.

The system helps a user to generate a patent application by receiving an invention disclosure; locating key concepts in the invention disclosure and searching for patent references of interest; displaying sample patent references without user request to use as drafting examples; receiving one or more drawings generated by a camera, a diagramming tool, a drawing tool, a presentation tool, or a word document editor. The user can annotate the drawings with reference numerals and pointer lines; move the reference numerals and pointer lines to desired positions; and generate text description for each drawing. When the application is near finish, the user can diagnose the drawing and text description to comply with formality requirements. At a desktop computer, the system can synchronize the files and be edited on a desktop computer. When the user is satisfied, the system can generate the patent application as Word, PDF, XML, or other suitable formats.

In one embodiment, the system can partially automatically generate the description text based on the keywords. In this process, the disclosure is parsed for key words, and such key words are graphically displayed for the user to sketch an outline of the invention including the novel components. The other keywords in the summary of the invention can be used in dependent claims. A stress test can be applied to the independent claims by performing a search on the key words in the independent claims, and a virtual examiner can apply the prior art to challenge the user. The stress test can apply an anticipation test under 35 USC Section 102 and an obviousness test under Section 103. By going through a simulated rejection, the quality of the claim can be enhanced because the user is forced to defend the scope of his or her claims.

In another embodiment, once keywords are identified and the drawings are imported, the system can attempt to automatically fill in the description on behalf of the user. For example, the system can locate patents or Wikipedia entries relating to the keywords, and use the background information from the patents to describe the keywords in the drawing. Further, the keyword description can be supplemented using “subjective knowledge extraction” such as Quora. By combining an answer voting mechanism and a reward addiction loop (upvotes are crack) with a strict identity requirement and a one-to-many follower model, Quora extracts high-quality experiential knowledge out of people's collective head and puts the knowledge it into structured form on the internet. Quora is also using humanity's collective wisdom to rank it. With this engine, Quora's database of human experience can contain the answers to a lot of questions people carrying tablets, smart phones such as the iPhones of the future might have. In another embodiment, the system translates the key works into targeted API calls that subsequently pull out the correct information from a potentially ever-expanding set of databases. Thus, the system can get the best answers to the majority of keyword queries from the concentrated knowledge and experience of its most articulate experts.

FIG. 13 shows an exemplary process to generate a utility patent application. The process can be used to graphically generate a patent application. In this process, a user generates a brief invention disclosure. The system gets the initial disclosure from the inventor (10). Such disclosure is typically brief and provides a conceptual basis for a patent application, and needs to be expanded in the detailed description of the invention. The process of FIG. 1 extracts key concepts from the disclosure (12). For example, the disclosure can contain a title, background, and a summary or abstract. In one embodiment, key noun phrases from the disclosure are identified. Key concepts can be determined by clustering the text, or alternatively by applying various factors, one of such is the frequency of occurrence in the disclosure. For example, the most frequently used noun phrases can be used as a seed for generating the broadest claim (independent claim), and the remaining claims can become dependent claims.

The process then display potential claim elements as graphical blocks and allows the user to add, edit or move the graphical blocks to better clarify the language and to better show the dependency relationship (54). The relationship between blocks is graphically shown as links between blocks. The process then generates claims based on the phrases and the relationship (such as the links) from the graphical diagram (56).

The process then prompts the user to generate drawings showing the claim elements with number annotation (58). In one embodiment, the diagram with the graphical blocks can itself be used as a figure in support of the application.

The process then prompts the user to provide more details and more description for each element and noun phrases. To assist the user, information from dictionary and thesaurus can be presented to help the user communicate more clearly. The details and dependency and relationship among the noun phrases and elements are described in depth in this manner (60).

Next, the process prompts the user to generate the background, abstract and brief description of the drawings (62). The background can be a simple paragraph or even a sentence. The abstract is a simplified version of claim 1 in one embodiment. The brief description of the drawings is simply a listing of the drawings.

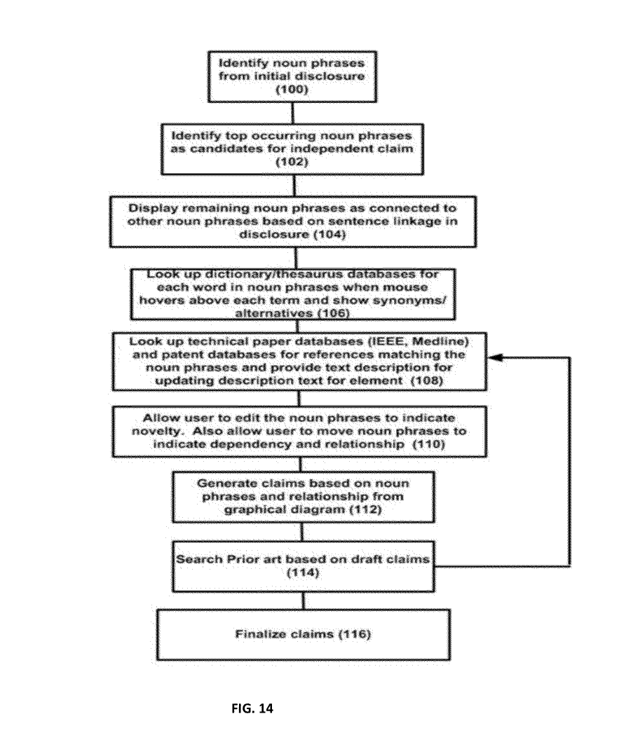

FIG. 14 shows an exemplary process to generate claims. First, noun phrases from the initial disclosure are generated (100). Next, the process identifies the most pertinent noun phrases as candidates for elements in the independent claims 102). In one embodiment, the process locates the two most commonly occurring noun phrases in the initial disclosure as a starting point. Other ways to identify candidates for the independent claim elements can be done. For example, the user can shift click a number of noun phrases to select them. Alternatively, the system can perform a search of the prior art and locates a combination of elements that do not exist in a single prior art document.

The process then displays the remaining noun phrases as dependent claims 104). These elements are linked to the elements in the parent claims based on the connections in the disclosure. For example, if the disclosure noted that “the engine can be a gas engine with spark plug”, the system then diagrams “gas engine” as linked to “engine” and further links “spark plug” to “gas engine”. The user can override such linkage my manually dragging and dropping the block to another block to signify that the second block is the dominant or parent element of the dragged block. To aid the user, the system looks up the dictionary and/or thesaurus for each term (106). The information can be displayed when the mouse hovers over the graphical block or in a report. These alternatives can be considered by the inventor and then the alternative terms can be weaved into the description section. In one embodiment, the system looks up definitions of the same term from other patent documents and presents them as alternative text to the drafter.

The process allows the user to edit the noun phrases if needed to indicate novelty (108). Novelty can also be achieved through the relationship of the elements, and the user can drag and drop the graphical block(s) to clarify the novel arrangement for elements that may exist in the art already.

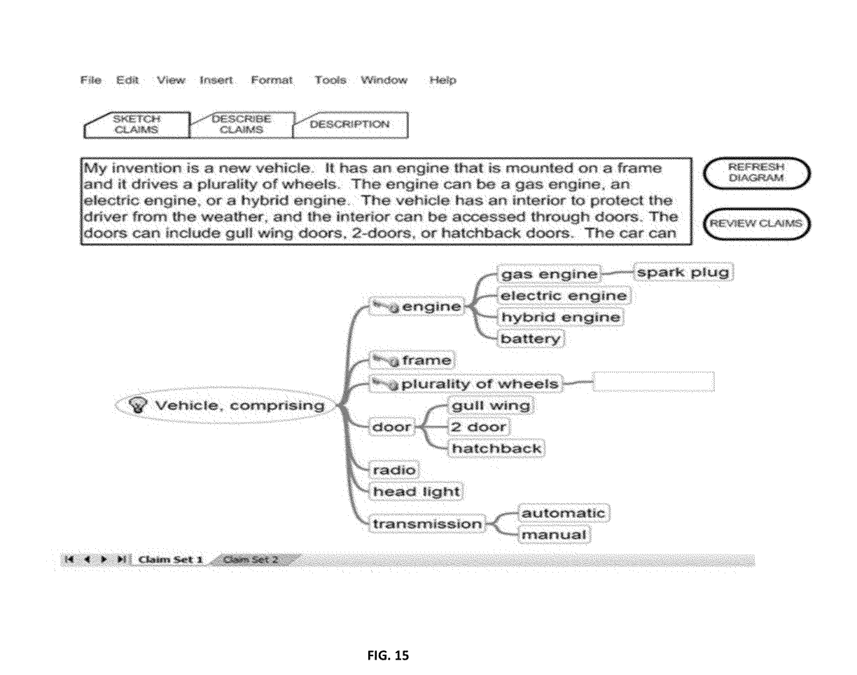

The process then generates draft claims for the user based on the refined claim elements and/or their connections to other elements in the claim (112). Once we have the relationship, the claims can be generated easily. For example, given the sketch of FIG. 15, one set of draft claims can be:

Vehicle, comprising
engine
gas engine

spark plug
electric engine
hybrid engine
battery

frame
plurality of wheels

door
gull wing
2 door
hatchback
radio
head light

transmission
automatic
manual

Since engine, frame, and plurality of wheels are marked as key, the system automatically generates a set of claims in this example as follows:

1. A vehicle, comprising:
an engine;
a frame coupled to the engine; and
a plurality of wheels coupled to the frame.

2. The vehicle of claim 1, wherein the engine comprises a gas engine.

3. The vehicle of claim 2, wherein the gas engine comprises a spark plug.

4. The vehicle of claim 1, wherein the engine comprises an electric engine.

5. The vehicle of claim 1, wherein the engine comprises a hybrid engine.

6. The vehicle of claim 1, comprising a door.

7. The vehicle of claim 6, wherein the door comprises a gull wing.

8. The vehicle of claim 6, wherein the door comprises a 2 door.

9. The vehicle of claim 6, wherein the door comprises a hatchback.

10. The vehicle of claim 1, comprising a radio.

11. The vehicle of claim 1, comprising a head light.

12. The vehicle of claim 1, comprising a transmission.

13. The vehicle of claim 12, wherein the transmission comprises automatic transmission.

14. The vehicle of claim 12, wherein the transmission comprises manual transmission.

In one implementation, the system collects all patents relating to a technology and clusters elements in each claim into clusters of elements. For each claim element the system puts together a corresponding description of text for each claim and these descriptions will appear in the description section. The claims initially we can manually supply.

The software runs a check to make sure that you have used element numbers in a consistent manner. For utility applications, the diagnostic features antecedent basis checking and support for claim elements in the detailed description. The diagnostic can also extract numbers from the drawings (such as from Visio or Powerpoint drawing files), and compare the numbers to those in the text description. Additionally, the element numbers in the text description are also identified. Variances in the number and text description thereof are flagged for user review.

In one embodiment, the user can preview the application as a PDF document, save as a PDF document, or save as a Word document. Upon success, the PDF is generated so that the user can file the application. To simplify, the PDF can include the Cover Sheet form first, followed by the description and then by the drawings, all in one document for ease of handling. Alternatively, the coversheet can be separate from the application PDF.

The filing page allows the user to file using paper or file on-line. To file using paper, the software runs the text through a final diagnostics, and if acceptable, prints a copy of the application for mailing. To file on-line, the user simply clicks on the “File On-Line” button. This will launch a browser window to the unregistered efiler page such as the efiling page hosted by the USPTO. The user can enter name, email address, click on the appropriate patent filing document to upload to the efiling portal.

The process helps a user to generate a patent application by receiving an invention disclosure; locating key concepts in the invention disclosure and searching for patent references of interest; displaying sample patent references without user request to use as drafting examples; receiving one or more drawings generated by a camera, a diagramming tool, a drawing tool, a presentation tool, or a word document editor. The user can annotate the drawings with reference numerals and pointer lines; move the reference numerals and pointer lines to desired positions; and generate text description for each drawing. When the application is near finish, the user can diagnose the drawing and text description to comply with formality requirements. When the user is satisfied, the system can generate the patent application as Word, PDF, XML, or other suitable formats.

In one embodiment, the system can partially automatically generate the description text based on the keywords. In this process, the disclosure is parsed for key words, and such key words are graphically displayed for the user to sketch an outline of the invention including the novel components. The other keywords in the summary of the invention can be used in dependent claims. A stress test can be applied to the independent claims by performing a search on the key words in the independent claims, and a virtual examiner can apply the prior art to challenge the user. The stress test can apply an anticipation test under 35 USC Section 102 and an obviousness test under Section 103. By going through a simulated rejection, the quality of the claim can be enhanced because the user is forced to defend the scope of his or her claims.

In another embodiment, once keywords are identified and the drawings are imported, the system can attempt to automatically fill in the description on behalf of the user. For example, the system can locate patents or Wikipedia entries relating to the keywords, and use the background information from the patents to describe the keywords in the drawing. Further, the keyword description can be supplemented using “subjective knowledge extraction” such as Quora. By combining an answer voting mechanism and a reward addiction loop (upvotes are crack) with a strict identity requirement and a one-to-many follower model, Quora extracts high-quality experiential knowledge out of people's collective head and puts the knowledge it into structured form on the internet. Quora is also using humanity's collective wisdom to rank it. With this engine, Quora is building a database of human experience that could eventually contain the answers to a lot of questions people carrying the iPhones of the future might have. In another embodiment, the system translates the key works into targeted API calls that subsequently pull out the correct information from a potentially ever-expanding set of databases. Thus, the system can get the best answers to the majority of keyword queries from the concentrated knowledge and experience of its most articulate experts.

In one embodiment for auto-generate the claims, noun phrases from the initial disclosure are generated. Next, the process identifies the most pertinent noun phrases as candidates for elements in the independent claims. In one embodiment, the process locates the two most commonly occurring noun phrases in the initial disclosure as a starting point. Other ways to identify candidates for the independent claim elements can be done. For example, the user can shift click a number of noun phrases to select them. Alternatively, the system can perform a search of the prior art and locates a combination of elements that do not exist in a single prior art document.

The process then displays the remaining noun phrases as dependent claims. These elements are linked to the elements in the parent claims based on the connections in the disclosure. For example, if the disclosure noted that “the engine can be a gas engine with spark plug”, the system then diagrams “gas engine” as linked to “engine” and further links “spark plug” to “gas engine”. The user can override such linkage my manually dragging and dropping the block to another block to signify that the second block is the dominant or parent element of the dragged block.

To aid the user, the system looks up the dictionary and/or thesaurus for each term. The information can be displayed when the mouse hovers over the graphical block or in a report. These alternatives can be considered by the inventor and then the alternative terms can be weaved into the description section. In one embodiment, the system looks up definitions of the same term from other patent documents and presents them as alternative text to the drafter.

The process allows the user to edit the noun phrases if needed to indicate novelty. Novelty can also be achieved through the relationship of the elements, and the user can drag and drop the graphical block(s) to clarify the novel arrangement for elements that may exist in the art already.

The process then generates draft claims for the user based on the refined claim elements and/or their connections to other elements in the claim. Once we have the relationship, the claims can be generated easily.

More than one set of claims can be done. For example, the process can draft a method claim and then prompt the user to do an apparatus version of his or her invention. Optionally, the process can bring the user to a patent search engine such as those provided by the USPTO or the EPO to search prior art. The process can assist the user with performing the search by providing the noun phrases in the independent claim in the search user interface. This default can be modified by the user to located relevant prior art. Based on the prior art search, the user may optionally modify the noun phrases by looping back. Alternatively, the process finalizes the claims and saves the final version in a Word application document for the user to include in the draft application.

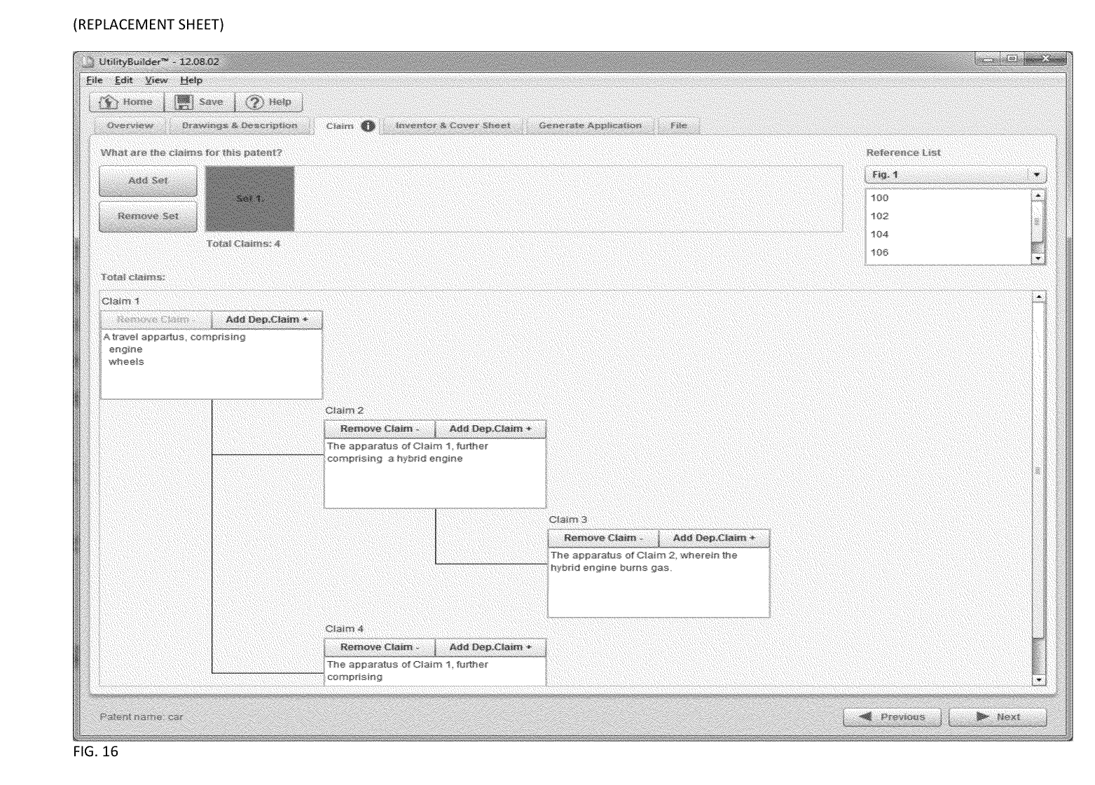

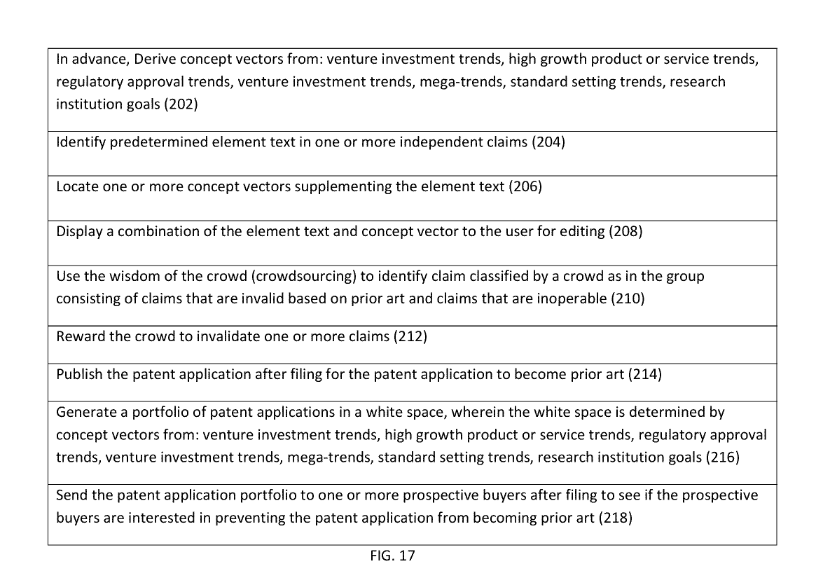

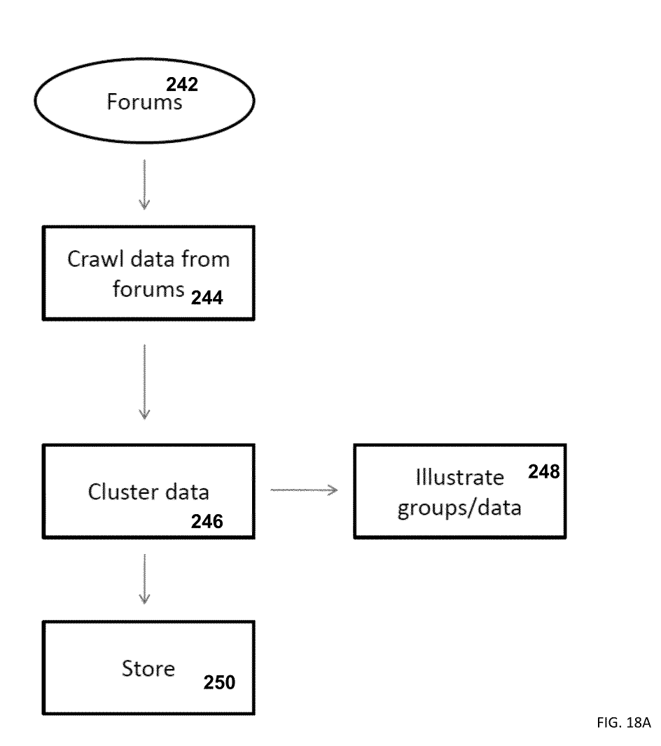

FIG. 15 shows an exemplary user interface to graphically sketch claims. In this embodiment, the user interface provides the usual menu system on top. Below the menu are tabs “Sketch Claims”, “Describe Claims”, and “Description.” The Sketch Claim user interface is shown in FIG. 15, while the Describe Claims tab is shown in FIG. 16, and the Description tab is shown in FIG. 17.

In the embodiment of FIG. 15, below the tabs is a copy of the invention disclosure. The user can open the invention disclosure and then can edit the text from the window, or alternatively the user can start a new disclosure directly using the Sketch Claims tab. A Refresh Diagram button can be clicked to refresh the claim diagram below, and the Review Claims button can be used to generate draft claims based on the current relationship sketched using the graphical edit tool. In one embodiment, the graphical edit tool can be a flow charting tool, a drawing tool, or any suitable sketching tool such as AutoCAD, Visio, Draw, or PowerPoint, among others.

In another embodiment, the tool can be a mind-mapping tool such as MindJet or FreeMind. A mind map is a diagram used to represent words, ideas, tasks, or other items linked to and arranged around a central key word or idea. Mind maps are used to generate, visualize, structure, and classify ideas, and as an aid in study, organization, problem solving, decision making, and writing. The elements of a given mind map are arranged intuitively according to the importance of the concepts, and are classified into groupings, branches, or areas, with the goal of representing semantic or other connections between portions of information. By presenting ideas in a radial, graphical, non-linear manner, mind maps encourage a brainstorming approach to planning and organizational tasks. Though the branches of a mindmap represent hierarchical tree structures, their radial arrangement disrupts the prioritizing of concepts typically associated with hierarchies presented with more linear visual cues. This orientation towards brainstorming encourages users to enumerate and connect concepts without a tendency to begin within a particular conceptual framework.

In one embodiment, the graphical edit tool is FreeMind, which provides features such as Fast one-click navigation, including folding/unfolding on one click and following links on one click at the same time. The user can move the map by dragging the map's background as well as using mouse wheel; Undo; Smart Drag'n Drop, including the possibility to copy nodes or copy style of nodes; dragging and dropping of multiple selected nodes; dropping of texts or list of files from outside; Smart copying and pasting into, including pasting of links from HTML or structuring the pasted content on the basis of the number of leading spaces in a line; pasting of lists of selected files; Smart copying and pasting from, including plain text and RTF (MS Wordpad, MS Word, MS Outlook messages).

In the embodiment of FIG. 16, the elements selected to be the independent claim have a key icon to indicate that these elements are important and will be in the independent claims. The tool supports multiple claim sets, and each claim set can be named. By pressing the arrows, the user can navigate to different claim sets.

In this embodiment, a spreadsheet is used to provide space to describe each element. A column containing the element number is also provided in the spreadsheet. The user can update the element number, and the element description. Once done, the information can be used to generate the Detailed Description of the Invention.

FIG. 16 shows an exemplary system that allows a user to graphically generate a claim outline. In one embodiment, a set of claim can be added or deleted as a group. The set can be a set of apparatus claims, or a set of method claims, for example. Once a new set is added, a text box receives user input for the claims. Each text box has a button to add dependent claims or to remove the claim. The user can enter the claim text, aided by the element number list. In one embodiment, each element number is associated with element text, and the user can double click on the corresponding text or drag-n-drop the text to the textbox for the claim to add the element to the claim. Given the claim tree of FIG. 16, in one embodiment, the user can drag-n-drop one claim to depend from another claim to graphically indicate the dependency for the claim relative to other claims. The user can also drag-and-drop at least one claim element in the outline to indicate position and relationship of the claim element to another claim element in the same claim. In one embodiment, the software operates by listing one or more element numbers and corresponding element text and dragging-and-dropping the element text to create an outline of the claim with predetermined claim element position and relationship to another claim element. The software can examine the application filing document for an element number used to describe two unrelated items in the drawing. The software can also examine the application filing document for antecedent basis error in a claim. In one embodiment, inventors may wish to delay examination of the application to minimize cash flow while he/she is exploring commercialization of the invention. This can be done by generating a document that requests suspension of prosecution to explore commercialization possibility for the invention.

FIG. 17 shows an exemplary process for automatically enhancing the inventor's ideas. First, during a training phase done in advance of real-time operation, the system derives concept vectors from: venture investment trends, high growth product or service trends, regulatory approval trends, venture investment trends, mega-trends, standard setting trends, research institution goals (202).

Identify predetermined element text in one or more independent claims (204)
Locate one or more concept vectors supplementing the element text (206)
Display a combination of the element text and concept vector to the user for editing (208)
Use the wisdom of the crowd (crowdsourcing) to identify claim classified by a crowd as in the group consisting of claims that are invalid based on prior art and claims that are inoperable (210)
Reward the crowd to invalidate one or more claims (212)
Publish the patent application after filing for the patent application to become prior art (214)
Generate a portfolio of patent applications in a white space, wherein the white space is determined by concept vectors from: venture investment trends, high growth product or service trends, regulatory approval trends, venture investment trends, mega-trends, standard setting trends, research institution goals (216)
Send the patent application portfolio to one or more prospective buyers after filing to see if the prospective buyers are interested in preventing the patent application from becoming prior art (218)

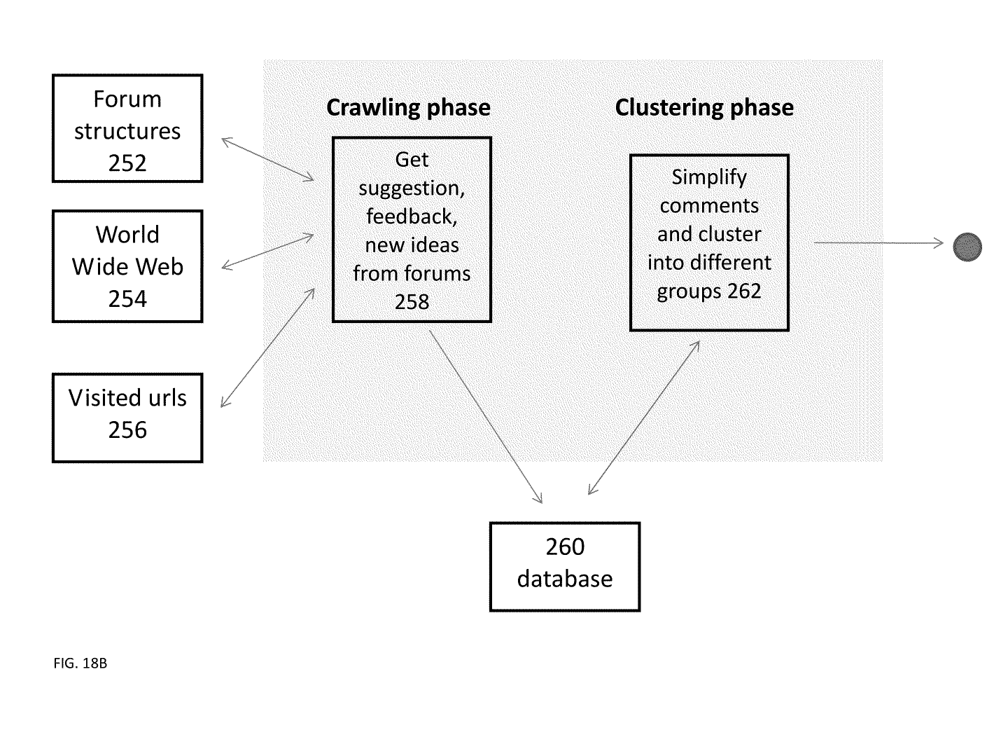

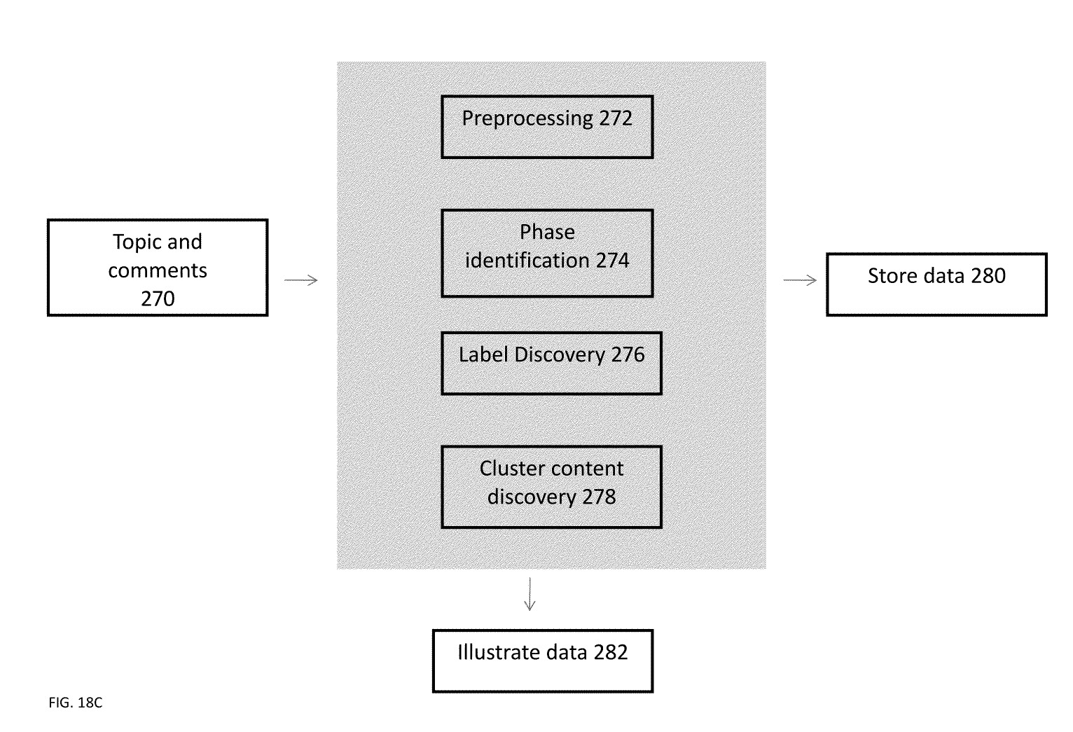

FIG. 18A-18B show one embodiment of a system for gathering data to help complete a patent application. In FIG. 18A, data from sites such as forums 242 are crawled (244). The data is clusterized and grouped into similar concepts (248) and then stored (250). In FIG. 18B, forum structures 252, Web content 254 and secondary addresses 256 are crawled. The system crawls the web to get improvement suggestions from users, feedback from customers, regulatory requirements, and venture investment trends and megatrends, among others, using a crawler 258. The output of the crawler 258 is stored in a database 260. A clusterizer 262 organizes the crawled content into similar groups for subsequent usage. FIG. 18C shows an exemplary process for clustering concepts. Topics and comments are retrieved (270). The data is pre-processed (272) and identified (274). The process discovers text labels (276), and clusterizes the content (278). The data is stored (280) and can be used to illustrate to users (282).

In one embodiment, the system captures the following information from Web sites on data such as:
Venture investment trends: The system can search various on line sources such as venture capital association or other groups. The system can pull investment trends from the National Venture Capital Association (NVCA.org) which serves as the definitive resource for venture capital data in the US, but non US venture investment data is also examined. The system can also search the MoneyTree Report, a quarterly study of venture capital investment activity in the United States. The MoneyTree Report is one source of information on emerging companies that receive financing and the venture capital firms that provide it.
Mega-trends and high growth product or service trends: In one embodiment, the system tracks sources that lead the global conversation about technologies that matter. For example, MIT Technology Review covers a broad spectrum of technology and identifies important new technologies—deciphering their practical impact and revealing how they will change people's lives. For computer technology, one source is Wired Magazine, which is a magazine to explore the world of computers, electronics, trends, science, and social media. Group discussions at LinkedIn can be analyzed. Many blog sources can be crawled, for example:
   TechCrunch—Interesting news and frequently first.
   VentureBeat—A firehose of news about startups, innovation, and cool products coming in the tech world.
   GigaOm—Some news, but mostly really smart analysis of the tech world.
   ReadWriteWeb—Mostly really smart analysis of the tech world. Some news, lots of smart people talking tech.
   Webware—News, always with a focus on “what does it mean for users?”
   Mashable—Nowhere else to go for social media news, this one's dominant.
   Bits—Not a lot of exclusive content, but brilliant writers and smart commentary.
   The Unofficial Apple Weblog—An awesome resource for anything and everything Apple.
   Business Insider Tech—Very business-heavy, but great angles on news stories.
   Ars Technica—Heavy on the geekery, but full of interesting thoughts and niche pieces.
   Reddit Technology—Not a blog per se, but a great source for tech news and other edifying and entertaining content.
   Six Revisions—Tips, tools, and great lists of design resources.
   Design Observer—More tips, tricks, and tutorials.
   Swiss Miss—The musings of a designer, with a heavy focus on the funky and quirky bits of the design world.
   MakeUseOf—Endless resource of Top 10 Lists, and geeky hacks you might want to try.
   gHacks—Deeper cuts in tech than MUO, but still great for news, tips, and tutorials.
   Lost in Technology—Much more approachable than the above sites, it's a great blog to wade into without much knowledge required.
   Mac AppStorm and Web AppStorm—The best Mac or Web apps.
   Switched—All things geek, particularly the culture of techies that is forming.
   Make Magazine—Do awesome stuff with your stuff. That should totally be their tagline.
   Gizmodo—Gadgets, gadgets, gadgets!
   Engadget—Oh my goodness, more gadgets!
   Boy Genius Report—They're full of rumors and leaks, and are almost always right.
   jkOnTheRun—Arguably the most seasoned gadget-heads out there, they're a smart, thoughtful, and objective resource for all things gadget and mobile.
   Boing Boing—The interesting, quirky, strange, and weird things in the tech world.
   Neatorama—Awesome things. I think that's their only criteria for inclusion, and they stick to it well.
Regulatory approval trend: In one embodiment, the system tracks FDA approved innovator and generic drugs and therapeutic biological products at Drugs@FDA. The main uses of Drugs@FDA are: finding labels for approved drug products; finding generic drug products for an innovator drug product; finding therapeutically equivalent drug products for an innovator or generic drug product; finding consumer information for drugs approved from 1998 to present; finding all drugs with a specific active ingredient; and viewing the approval history of a drug. Drugs@FDA contains prescription and over-the-counter human drugs and therapeutic biologicals currently approved for sale in the United States. Drugs@FDA contains the following therapeutic biological products: monoclonal antibodies; cytokines, growth factors, enzymes, immunomodulators; and thrombolytics; proteins intended for therapeutic use that are extracted from animals or microorganisms, including recombinant versions of these products (except clotting factors); other non-vaccine therapeutic immunotherapies. Drugs@FDA contains most of the drug products approved since 1939. The majority of labels, approval letters, reviews, and other information are available for drug products approved from 1998 to the present. In another embodiment, the system tracks FCC approvals at FCC License View. FCC License View, part of the agency's spectrum inventory, is a single portal for information on the management of licenses. The system uses License View to get data snapshots such as the number of licenses across different services, how many licenses are held by different entities, and how many licenses are up for renewal in the near future.
Standard setting trends: In one embodiment, the system analyzes developments at the IEEE standards working group at http://standards.ieee.org/develop/index.html that covers Aerospace Electronics, Antennas & Propagation, Batteries, Communications, Computer Technology, Consumer Electronics, Electromagnetic Compatibility, Green & Clean Technology, Healthcare IT, Industry Applications, Instrumentation & Measurement, Nanotechnology, National Electrical Safety Code, Nuclear Power, Power & Energy, Power Electronics, Smart Grid, Software & Systems Engineering, Transportation, Wired & Wireless, among others. Other technology associations for Chemical Engineering, Material Science, and Biological Science, among others, can be analyzed as well.
research institution goals: the system can crawl all university research microsites and collect information about interesting research done by professors. Each professor typically has a research page that highlights their research, people, and relevancy of the research. The system would index each professor, team members, and then retrieves all research papers by each team member.

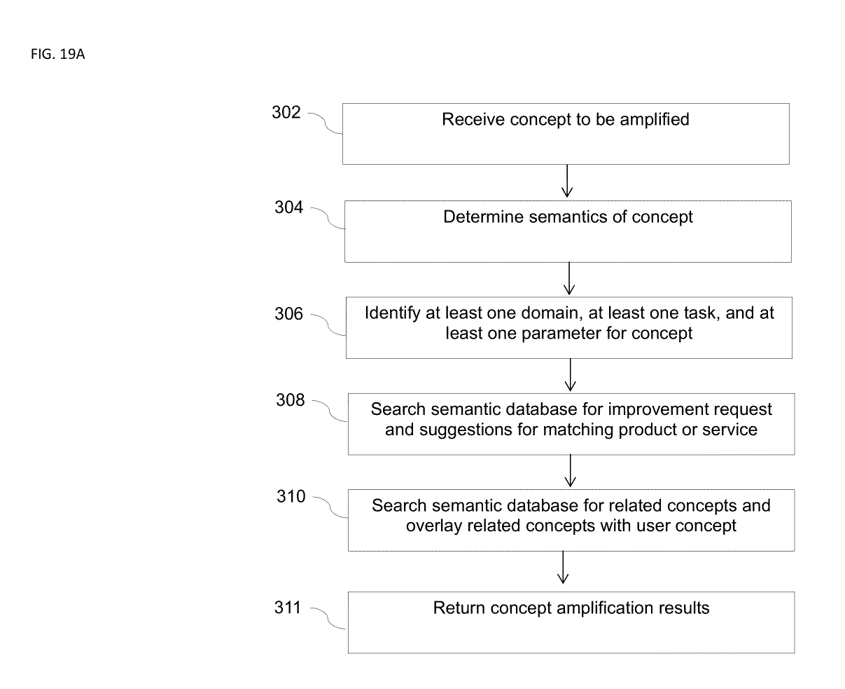

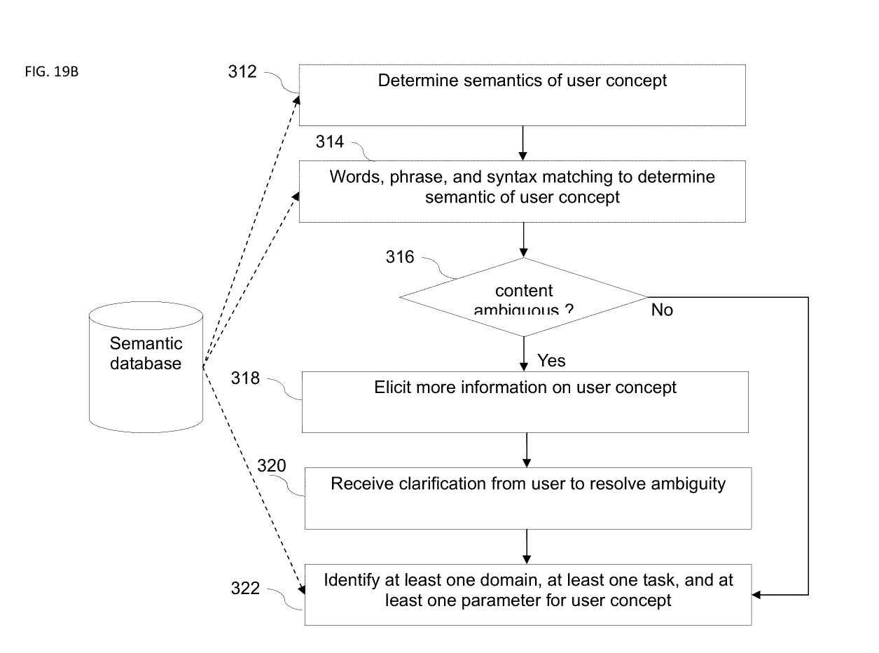

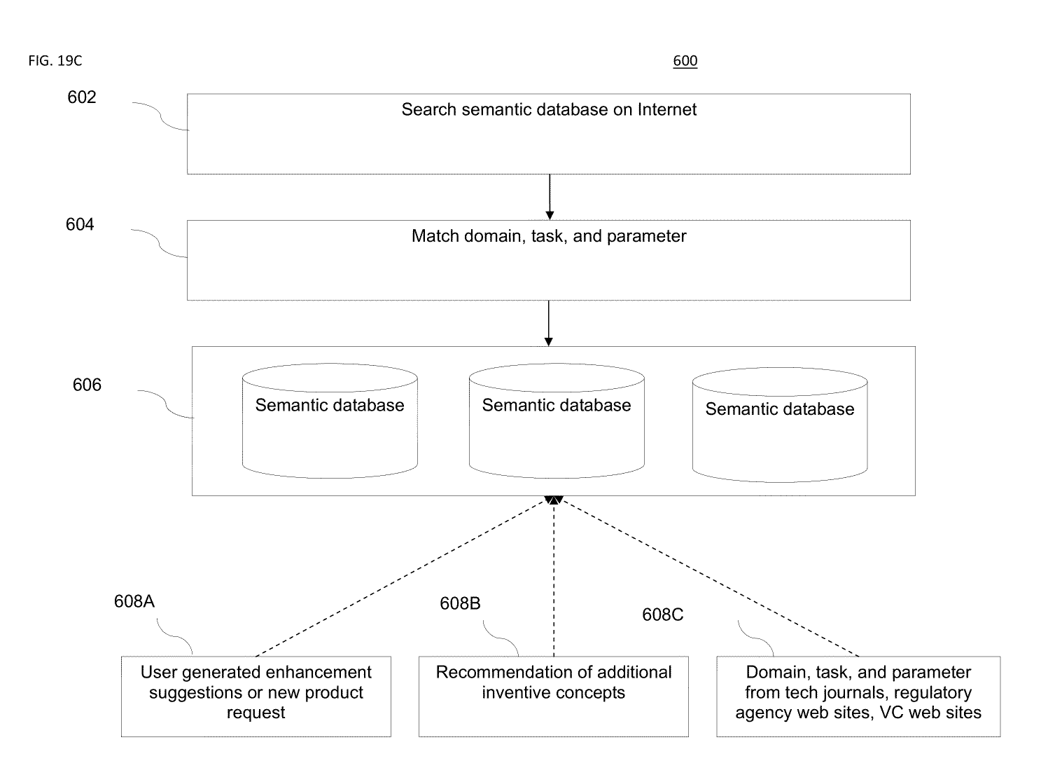

FIGS. 19A-19C show one exemplary embodiment for amplifying an inventive concept and auto-generating the text for the amplified concept. Turning now to FIG. 19A, at 302, the system receives a concept to be amplified and determines concept semantics to be amplified at 304. By amplifying ideas, the system attempts to bring positive change to the original concept and the environment. The software increases the capability of a person to approach a complex problem situation, to gain comprehension to suit his/her particular needs, and to derive solutions to problems. Increased capability in this respect is taken to mean a mixture of the following: more-rapid comprehension, better comprehension, the possibility of gaining a useful degree of comprehension in a situation that previously was too complex, speedier solutions, better solutions, and the possibility of finding solutions to problems that before seemed insolvable. And by complex situations the system can include the professional problems of diplomats, executives, social scientists, life scientists, physical scientists, attorneys, designers—whether the problem situation exists for twenty minutes or twenty years. The software provides an integrated domain where hunches, cut-and-try, intangibles, and the human feel for a situation usefully co-exist with powerful concepts, streamlined terminology and notation, sophisticated methods, and high-powered electronic aids.

At 306, the method may allow the computing device to determine semantics of the user request and identify at least one domain, at least one task, and at least one parameter for the user request. In an embodiment, the term semantic described herein may refer to signifiers or linguistics of the first language, such as used by the computing device in communication with the one or more servers, to identify expressions, words, phrases, signs or symbols, through the first language. The computing device may be configured to determine the semantics of the user request, using the techniques described herein, and may call external services to interface with a calendar function or application on the computing device. In an embodiment, the act of determining the semantics of the user voice request may include producing sorted indices for the semantic data, such as identified form the user voice data request.

At 308, the computing device may search a semantic database on the Internet for the at least one matching domain, task, and parameter. One embodiment works with the Web Ontology Language (OWL), a W3C Recommendation and a Semantic Web building block. OWL supports the kind of machine interpretability described above. The language is built on formalisms that admit to Description Logic (DL) forms and therefore allows reasoning and inference. Reasoning is the act of making implicit knowledge explicit. For example, an OWL knowledge base containing descriptions of students and their parents could infer that two students exhibited the ‘brother’ relationship if there were both male and shared one or more parent. No explicit markup indicating the ‘brotherhood’ relationship need ever have been declared. A Reasoning Engine is computational machinery that uses facts found in the knowledge base and rules known a priori to determine Subsumption, Classification, Equivalence, and so on. F-OWL, FaCT, and Racer are examples of such engines. OWL Full is so expressive that there are no computational guarantees that inferences can be made effectively and it is unlikely that any such engine will be able to support all its features soon. However, OWL Lite and subsets of OWL DL can be supported.

In an embodiment, the semantic database described herein may be a triple store database, such as operating one or more database management programmes to manage a triple store. In an embodiment, the term ‘triple’ described herein may refer to various elements of the user voice data request and their interrelationship as either “Subject”, “Verb”, or “Object”. In an embodiment, the term ‘triple’ described herein may refer to the use of the semantic data, such as identified form the user voice request. In an embodiment, the one or more database management programmes may be configured to collate selected triples, within the store, into the triple store database, such as when the selected sets of triples is accessed in the course of executing a query on the store.

At 310, the method may allow the computing to amplify the user concept in accordance with the at least one matching domain, task, and parameter. In an embodiment, the computing device can be configured to provide assistance to the user in accordance with the request received from the user. The computing device may be configured, designed, or operable to provide various different types of operations, functionalities, services, or features. The computing device may be configured to automate the application of data and services, such as for example, but not limited to, purchase, reserve, or order products and services, available over the Internet. Consequently, the computing device may be configured to automate the process of using these data and services. The computing device may be further configured to enable the combined use of several sources of data and services. For example, the computing device may combine information about products from several sites, check prices and availability from multiple distributors, and check their locations and time constraints, and provide the user with personalized response for the requests.

The computing device may be configured to automate the use of data and services available over the Internet to find, investigate, suggest, or recommend the user about other inventive concepts to consider in addition to the original concept. In an embodiment, the computing device may be configured to automate the use of data and services available on the internet to find, investigate, suggest, or recommend places to go, such as for example, but not limited to, travel destinations, hotels, restaurants, bars, pubs, entertainment sites, landmarks, summer camps, resorts, or other places.

The computing device may be configured to enable the operation of applications and services via natural language processing techniques that may be otherwise provided by dedicated applications with graphical user interfaces.

FIG. 19B depicts a diagram, by way of example, but not by way of limitation, a method for natural language processing, according to an embodiment of the present invention. At 312, the method may allow the computing device to determine semantics of the user's inventive concept. The computing device may be configured to interpret the spoken voice of the user to determine the semantics of the user request. At 314, the method may allow the computing device to match the word, phrase, or syntax to determine semantics of the user inventive concept. The computing device, in communication with the semantic database, may be configured to automatically correct the syntactic or semantic errors identified from the user voice dictation.

In an embodiment, the computing device may be configured to determine the semantics of the user voice request such as by using the semantic database. In an embodiment, the semantic database, such as the triple store database, may be configured to take a large number of triple data and generate different interpretations, which may be sorted according to the triple parts identified form the user voice request. In an embodiment, the initial set of triples, may be stored as the user transaction history log. In an embodiment, the computing device may store the user history user history triples in a random order or a particular initial sorted order, such as determined subject-predicate-object, in accordance with the user voice inputs received from the user.

The different interpretations described herein may be ambiguous or need further clarification such as to facilitate the use of algorithms for efficient interpretation or analysis of the user voice request. At 316, the method may allow the computing device to determine if the user inventive concept identified from the user request is ambiguous to interpret. The focus on specific domains, tasks, and dialogs also makes it feasible to achieve coverage over domains and tasks with human-managed vocabulary and mappings from intent to services parameters.

In an embodiment, the triple store database may be configured to retrieve Meta schema information such as to better interpret the user inventive concept. In an embodiment, the Meta schema may contain the rules and regulations may be determined by the triple store, such as to generate interpretations, in accordance with the request received from the user. In an embodiment, the triple store database may link triple tuples, such as the subject, predicate, and object, to disambiguate the ambiguous interpretations of the user inventive concept.

In response to determining that the user voice data is ambiguous to interpret, the method 300 may allow the computing device to elicit more information on user request such as shown at 318. In an embodiment, the computing device may be configured to prompt the user for more information on the request such as to resolve the ambiguities from the user (320). In the embodiment, the computing device may prompt for more information on the request to the user, in communication with the one or more servers. The one or more servers described herein may include components such as, for example, vocabulary sets, language interpreter, dialog flow processor, library of language pattern recognizers, output processor, service capability models, task flow models, domain entity databases, master version of short term memory, master version of long term memory, or the like, such that the computing device may parse and interpret the user voice request.

The input and output data processing functionalities may be distributed among the user and the one or more servers. In an embodiment, the user may maintain a subsets or portions of these components locally, to improve responsiveness and reduce dependence on the network communications. Such subsets or portions may be maintained and updated according to the cache management techniques known in the art. Such subsets or portions include, for example, vocabulary sets, library of language pattern recognizers, master version of short term memory, master version of long term memory, or the like.

At 320, the method 300 may allow the computing device to receive clarification from the user to resolve ambiguity associated with the user inventive concept. In an embodiment, the user may provide more information to the computing device such as to clarify the ambiguity in interpretation of the user voice request. In an implementation, the process may allow the triple store to generate queries such as to improve the interpretations of the user inventive concept, in accordance with the clarifications received for the user. In an embodiment, the method may allow the triple store to inversely map the one or more triples by swapping the subject, the predicate, or the object. In an embodiment, the triple (subject, predicate, or object) can be generated by constructing the inverse of the associative triples such as to analyze the better interpretations of the user request, thereby disambiguating the user voice data, in accordance with the clarifications received from the user.

The method may allow the computing device to parse the information received from the user, such as to identify at least two competing semantic interpretations of the user request. At 322, the method may allow the computing device, in communication with the semantic database, to identify at least one domain, at least one task, and at least one parameter for the user request.

FIG. 19C depicts a diagram, by way of example, but not by way of limitation, a method 600 for searching on Internet for amplification of the user's inventive concept, according to an embodiment of the present invention. At 602, the method 600 may allow the computing device to search semantic database on the Internet, in accordance with the request received from the user. In an embodiment, the method 600 may search for the at least one matching domain, task, and parameter in one of: a semantic tech blog, a semantic drug development database, a semantic nano-tech database, semantic DARPA research topic database, a semantic media database, a semantic book database, a semantic engineering database, or the like, such as shown at 604.

At 606, the method 600 may allow the computing device, in communication with the one or more servers, to search for the at least one matching domain, task, and parameter using a short term memory, a long term memory, the semantics database, or the like. In an embodiment, the short term personal memory described herein may be configured to store or implement various types of functions, operations, or actions, such as for example, but not limited to, maintaining a history of the recent dialog between the computing device and the user, maintaining a history of recent selections by the user in the GUI such as which items were opened or explored, which patents were reviewed, which items were mapped, and the like, maintaining the server session or user session state such as web browser cookies or RAM (Random Access Memory) used by the user or other applications, maintaining the list of recent user requests, maintaining the sequence of results of recent user requests, maintaining the click-stream history of UI events such as including button presses, taps, gestures, voice activated triggers, or any other user input, maintaining the computing device sensor data such as location, time, positional orientation, motion, light level, sound level, and the like. These functions, operations, or actions may be used by the one or more servers such as to search for the at least one matching domain, task, and parameter, in accordance with the request received from the user.

In an embodiment, the short term personal memory described herein may be configured to store or implement various types of functions, operations, or actions, such as for example, but not limited to maintaining the personal information and data about the user such as for example the user preferences, identity information, authentication credentials, accounts, addresses, or the like, maintaining information that the user has collected by the computing device such as the equivalent of bookmarks, favorites, clippings, or the like, maintaining saved lists of business entities including restaurants, hotels, stores, theatres, or other venues.

In an embodiment, the long-term personal memory may be configured to store information such as to bring up a full listing on the entities including prior inventions, conferences attended, magazines/blogs read, and the like. These functions, operations, or actions may be used by the one or more servers such as to search for the at least one matching domain, task, and parameter, in accordance with the request received from the user.

The one or more servers can be configured to use the short term memory, the long term memory, or the semantic database, in communication or a combination of portions to search for the at least one matching domain, task, and parameter, in accordance with the request received from the user. In an embodiment, the short term memory, the long term memory, or the semantic database may include user generated reviews, recommendations or suggestions, domains, tasks, and parameters, or the like, such as to provide personalized response to the client in accordance with the request received from the user, such as shown at 608A, 608B, and 608C.

At 608A, 608B, and 608C, in various embodiments, the method 600 may allow the semantic database, such as triple store database disclosed herein may be configured to integrate with various sites on the Internet such as to provide intelligent automated assistant to the user in accordance with the request received from the user. In an embodiment, the triple store database may be configured to integrate, implement, or combine information about one or more products from several review and recommendation sites. The review and recommendation described herein may be provided by the one or more users such as to check prices and availability from multiple distributors, and check their locations and time constraints, and help a user find a personalized solution to their problem.

In an embodiment, the triple store database may be configured to include functionality for automating the use of review and recommendation services available over the Internet. In an embodiment, the triple store database may be configured to store review and recommendation information related to, for example, but not limited to, things to do such as new trends, new inventions close to the inventive concept, or the like.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments. Thus, the present invention is not intended to be limited to the embodiments shown herein but is to be accorded the widest scope consistent with the principles and novel features disclosed herein.

What is claimed is:

1. A method for generating a patent application, comprising:
receiving a summary or abstract of an invention;
without user request, automatically searching for references of interest including matching patents or published applications and presenting the matching patents or published applications as examples to follow in drafting the patent application;
receiving one or more drawings and annotating the drawings with at least one numbered line whose curve is adjusted with two or more points on the line;
prompting the user to describe each drawing in a description;
capturing inventor information and generating a form selected from a group consisting of a provisional cover sheet and oath/declaration; and
generating an application filing document including the form and the patent application for uploading to a patent office portal that conforms to an open standard for electronic document exchange including one of: a Portable Document Format (PDF), an Extensible Markup Language (XML) format.

2. The method of claim 1, comprising generating a provisional application including capturing information to complete the provisional coversheet.

3. The method of claim 2, comprising converting the provisional application into a utility application by adding at least one claim.

4. The method of claim 3, comprising generating the utility application including capturing information to complete the oath/declaration and an application data sheet (ADS).

5. The method of claim 3, comprising generating an information disclosure statement (IDS) for uploading to the patent office portal.

6. The method of claim 1, comprising graphically generating a claim outline by dragging-and-dropping at least one claim element in the outline to indicate position and relationship of the claim element to another claim element in the claim.

7. The method of claim 1, comprising listing one or more element numbers and corresponding element text and dragging-and-dropping the element text to create an outline of the claim with predetermined claim element position and relationship to another claim element.

8. The method of claim 1, comprising examining the application filing document for an element number used to describe two unrelated items in the drawing.

9. The method of claim 1, comprising examining the application filing document for antecedent basis error in a claim.

10. The method of claim 1, comprising generating a document that requests suspension of prosecution to explore commercialization possibility for the invention.

11. The method of claim 1, comprising automatically augmenting the claims by:
identifying predetermined element text in one or more independent claims;
locating one or more concept vectors supplementing the element text; and
displaying a combination of the element text and concept vector to the user for editing.

12. The method of claim 11, comprising deriving concept vectors from: venture investment trends, high growth product or service trends, regulatory approval trends, mega-trends, standard setting trends, research institution goals.

13. The method of claim 11, comprising crowdsourcing to remove a claim classified by a crowd as in the group consisting of claims that are invalid based on prior art and claims that are inoperable.

14. The method of claim 11, comprising rewarding the crowd to invalidate one or more claims.

15. The method of claim 11, comprising publishing the patent application after filing for the patent application to become prior art.

16. The method of claim 15, comprising sending the patent application to one or more prospective buyers after filing to see if the prospective buyers are interested in preventing the patent application from becoming prior art.

17. The method of claim 11, comprising generating a portfolio of patent applications in a white space, wherein the white space is determined by concept vectors from: venture investment trends, high growth product or service trends, regulatory approval trends, mega-trends, standard setting trends, research institution goals.

18. The method of claim 11, comprising
determining semantics of a user inventive concept and identifying at least one domain, at least one task, and at least one parameter for the user concept;
searching a semantic database on the Internet for the at least one matching domain, task, and parameter; and
displaying alternative inventive concepts to the user.

19. The method of claim 11, comprising filing the patent application without paying an application filing fee and receiving crowd-sourced comments before deciding to pay the application filing fee or to abandon the patent application.

20. The method of claim 11, comprising searching the Internet for products or services matching elements of each independent claim.
